(19) United States
(12) Patent Application Publication
(10) Pub. No.: US 2025/0390567 A1
(43) Pub. Date: Dec. 25, 2025

(54) IMAGE CAPTURING APPARATUS CAPABLE OF PERFORMING BIOMETRIC AUTHENTICATION, METHOD OF CONTROLLING IMAGE CAPTURING APPARATUS, AND STORAGE MEDIUM

(71) Applicant: CANON KABUSHIKI KAISHA, Tokyo (JP)

(72) Inventors: TAKAYUKI HOSHINA, Kanagawa (JP); TAKUMA IWAGAMI, Kanagawa (JP)

(21) Appl. No.: 19/234,754

(22) Filed: Jun. 11, 2025

(30) Foreign Application Priority Data
Jun. 19, 2024 (JP) 2024-098788

(51) Int. Cl. G06F 21/32

(52) U.S. Cl. CPC G06F 21/32

(57) ABSTRACT

An image capturing apparatus includes an image capturing section that performs an image capturing process to generate image data, a system memory section that temporarily stores the image data, a biometric information acquisition section that acquires biometric information of an operator who performs an operation of instructing the image capturing process, and a controller that performs a biometric authentication process for authenticating the operator based on the acquired biometric information. When the image capturing process is started, the biometric authentication process is started. If the biometric authentication process is not terminated before terminating the image capturing process, the image data generated by the image capturing process is temporarily stored in the system memory section, and if the biometric authentication process is terminated after temporarily storing the image data, a result of the biometric authentication process is added to the temporarily stored image data.

### BACKGROUND

### Field of the Technology

The present disclosure relates to an image capturing apparatus that is capable of performing biometric authentication, a method of controlling the image capturing apparatus, and a storage medium.

### Description of the Related Art

In recent years, an electronic apparatus, such as a digital camera, a smartphone, or a tablet terminal, that is capable of shooting e.g. a still image or a moving image and recording a captured image as an image file has become popular. Further, a user of the electronic apparatus can upload the image file e.g. on the Internet. Then, there is a case where an image file uploaded on the Internet is illegally duplicated or processed by a third party (outsider). There is a fear that such duplication and processing can be actions which cannot be ignored by the user. Therefore, there is a strong demand for a countermeasure for protecting the right of the author of the image file. To meet the demand, as a copyright protection measure, for example, an industry association, such as Coalition for Content Provenance and Authenticity (C2PA), has been established, that addresses development of a technical standard for authenticating a source and history of an image file. Each company belonging to this industry association is establishing a technique for certifying validity of an information source of an image file. For example, Japanese Laid-Open Patent Publication No. 2020-21127 discloses an information processing system that has a biometric authentication function and improves the reliability of storage of image data (image file) by using the biometric authentication. This information processing system is configured to permit image capturing on condition that the biometric authentication is successful.

However, to perform a biometric authentication, although depending on a configuration and a method of the biometric authentication, for example, it generally takes approximately 300 to 500 ms, and hence in the information processing system described in Japanese Laid-Open Patent Publication No. 2020-21127, image capturing is not permitted during execution of the biometric authentication. For example, even when a time at which a user desires to perform image capturing comes during the biometric authentication, and an operation for image capturing is performed, the shooting opportunity can be lost since image capturing is not permitted.

### SUMMARY

The present disclosure is directed to provide, an image capturing apparatus capable of performing biometric authentication, which is capable of reducing an influence of time required to perform biometric authentication on image capturing, a method of controlling the image capturing apparatus, and a storage medium.

In a first aspect of the present disclosure, there is provided an image capturing apparatus including an image capturing unit configured to perform an image capturing process for capturing an image to thereby generate image data, a temporary storage unit configured to temporarily store the image data for provisional storage, an acquisition unit configured to acquire biometric information of an operator who performs an operation of instructing the image capturing process, a biometric authentication unit configured to perform a biometric authentication process for authenticating the operator based on the biometric information acquired by the acquisition unit, and a control unit configured to control the image capturing unit, the temporary storage unit, the acquisition unit, and the biometric authentication unit, respectively, wherein the control unit controls the image capturing unit to start the image capturing process, controls the biometric authentication unit to start the biometric authentication process, temporarily stores the image data generated by the image capturing process in the temporary storage unit in a case where the biometric authentication process is not terminated before the image capturing process is terminated, and adds, in a case where the biometric authentication process is terminated after the image data has been temporarily stored, a result of the biometric authentication process to the image data temporarily stored in the temporary storage unit.

In a second aspect of the present disclosure, there is provided an image capturing apparatus including an image capturing unit configured to perform an image capturing process for capturing an image to thereby generate image data, an acquisition unit configured to acquire biometric information of an operator who performs an operation of instructing the image capturing process, a biometric authentication unit configured to perform a biometric authentication process for authenticating the operator based on the biometric information acquired by the acquisition unit, a detection unit configured to detect a first operation and a second operation, sequentially performed by the operator with a time difference therebetween, and a control unit configured to control the image capturing unit, the acquisition unit, the biometric authentication unit, and the detection unit, respectively, wherein in a case where the first operation is detected by the detection unit, the control unit controls the biometric authentication unit to perform the biometric authentication process, and in a case where the biometric authentication process is successful, until the second operation is detected, the control unit adds information concerning the successful biometric authentication process to the image data generated by the image capturing process before the second operation is detected.

In a third aspect of the present disclosure, there is provided an image capturing apparatus including an image capturing unit configured to perform an image capturing process for capturing an image to thereby generate image data, an acquisition unit configured to acquire biometric information of an operator who performs an operation of instructing the image capturing process, a biometric authentication unit configured to perform a biometric authentication process for authenticating the operator based on the biometric information acquired by the acquisition unit, and a control unit configured to control the image capturing unit, the acquisition unit, and the biometric authentication unit, respectively, wherein the control unit controls the image capturing unit to start the image capturing process and controls the biometric authentication unit to start the biometric authentication process, and in a case where the biometric authentication process is not terminated before the image capturing process is terminated, the control unit temporarily adds information related to the biometric information to the image data generated by the image capturing process.

According to the present disclosure, for the image capturing apparatus capable of performing biometric authentication, it is possible to reduce the influence of time required to perform biometric authentication on image capturing.

Features of the present disclosure will become apparent from the following description of embodiments with reference to the attached drawings. The following description of embodiments are described by way of example.

### BRIEF DESCRIPTION OF THE DRAWINGS

FIGS. 1A to 1C are diagrams showing an example of a configuration of an image capturing apparatus according to a first embodiment.

FIGS. 2A and 2B are a flowchart of a process performed by the image capturing apparatus.

FIGS. 3A to 3F are diagrams each showing an example of a screen displayed on a display section of the image capturing apparatus.

FIGS. 4A and 4B are a flowchart of a process performed by the image capturing apparatus according to a second embodiment.

FIG. 5 is a diagram showing a user database stored in a memory section of the image capturing apparatus according to a third embodiment.

FIGS. 6A and 6B are a flowchart of a process performed by the image capturing apparatus.

FIG. 7 is a flowchart of a process performed by the image capturing apparatus according to a fourth embodiment.

### DESCRIPTION OF THE EMBODIMENTS

The present disclosure will now be described in detail below with reference to the accompanying drawings showing embodiments thereof. The configurations described in the following embodiments are given only by way of example, and are by no means intended to limit the scope of the present disclosure. For example, components of the present disclosure can be replaced by desired components which can exhibit the same functions. Further, a desired component or components can be added. Further, two or more desired components (features) of the embodiments can be combined.

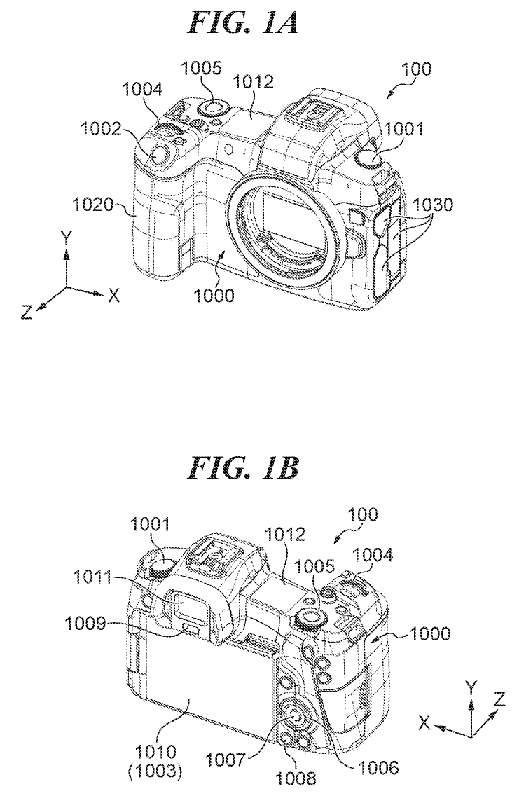

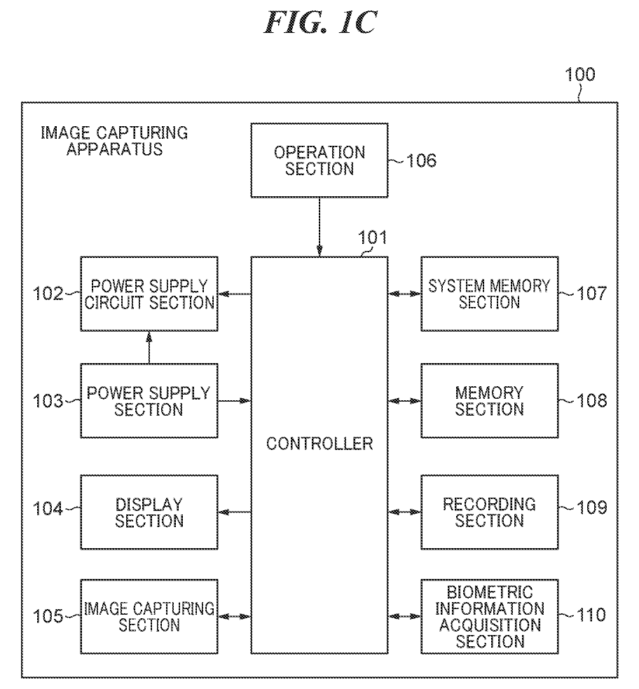

A first embodiment will be described below with reference to FIGS. 1A to 3C. FIGS. 1A to 1C are diagrams showing an example of a configuration of an image capturing apparatus according to the first embodiment. FIG. 1A is a front perspective view showing the appearance of the image capturing apparatus. FIG. 1B is a rear perspective view showing the appearance of the image capturing apparatus. FIG. 1C is a block diagram showing a hardware configuration of the image capturing apparatus. Note that in FIGS. 1A and 1B, a width direction of the image capturing apparatus is defined as an X direction, a height direction of the image capturing apparatus is defined as a Y direction, and a thickness direction of the image capturing apparatus, i.e. an optical axis direction is defined as a Z direction. The image capturing apparatus denoted by reference numeral 100, shown in FIGS. 1A and 1B, is a digital camera that is capable of shooting various types of images, such as a moving image and a still image. The image capturing apparatus 100 has a body 1000. This image capturing apparatus 100 has a main power button 1001, a release button 1002, a touch panel 1003, a main electronic dial 1004, and a sub electronic dial 1005, which are arranged on the body 1000. Further, the image capturing apparatus 100 has a cross key 1006, a SET button 1007, a reproduction button 1008, an eye-contact detection section 1009, a monitor 1010, a finder (eyepiece finder) 1011, and a display panel 1012, which are arranged on the body 1000. Further, the image capturing apparatus 100 has a grip part 1020 and a terminal section 1030, which are provided on the body 1000.

The main power button 1001 is an operation member for switching ON and OFF of power supply of the image capturing apparatus 100. The release button 1002 is an operation section for providing a shooting instruction to the image capturing apparatus 100. The touch panel 1003 can detect a touch operation performed on a display surface (operation surface) of the monitor 1010. The main electronic dial 1004 is rotatably supported, and a variety of settings, such as a shutter speed and an aperture, can be changed by rotating the main electronic dial 1004. The sub electronic dial 1005 is rotatably supported, and an operation of moving a selection frame, an operation of feeding an image, and so forth, on the monitor 1010 can be performed by rotating the sub electronic dial 1005. The cross key 1006 is supported such that an upper portion, a lower portion, a left portion, and a right portion can each be depressed in the Z direction, and can provide an operation instruction associated with a pushed portion. The SET button 1007 is mainly used e.g. for determining a selection item on the monitor 1010. The reproduction button 1008 can switch between a shooting mode and a reproduction mode of the image capturing apparatus 100. For example, when the reproduction button 1008 is pressed during the shooting mode, the image capturing apparatus 100 is shifted to the reproduction mode. With this, it is possible to display an image file (captured image data) recorded in a recording medium, such as a memory card, on the monitor 1010 or the finder 1011. The user can intuitively make a variety of settings by using a menu screen displayed on the monitor 1010 or the finder 1011, the cross key 1006, the SET button 1007, and so forth.

The eye-contact detection section 1009 is a sensor for detecting whether or not an eye of a photographer (user), i.e. an eye of an operator operating the image capturing apparatus 100 is close to the finder 1011. The monitor 1010 can display e.g. an image file and a variety of information. On the finder 1011, the photographer can visually recognize a video displayed on an internal electronic view finder (EVF) by bringing his/her eye into contact with the finder 1011. The display panel 1012 can display shooting conditions (settings), such as a shutter speed and an aperture. The grip part 1020 is a holding part formed into a shape easy to grasp by a right hand for the photographer to hold the image capturing apparatus 100. The release button 1002 and the main electronic dial 1004 are arranged at respective locations at which the photographer can operate these with the index finger of the right hand in a state in which the photographer holds the image capturing apparatus 100 by grasping the grip part 1020 with the little finger, the ring finger, and the middle finger of the right hand, and the sub electronic dial 1005 is arranged at a location at which the photographer can operate this with the thumb of the right hand. On the terminal section 1030, a connector (not shown) for a wired cable that connects between the image capturing apparatus 100 and an external apparatus, such as a personal computer, is arranged.

As shown in FIG. 1C, the image capturing apparatus 100 includes a controller (control unit) 101, a power supply circuit section 102, a power supply section 103, a display section (display unit) 104, and an image capturing section (image capturing unit) 105. Further, the image capturing apparatus 100 includes an operation section 106, a system memory section (temporary storage unit) 107, a memory section 108, a recording section (final storage unit) 109, and a biometric information acquisition section (acquisition unit) 110. The controller 101 is a computer comprised of at least one processor and controls associated sections ranging from the power supply circuit section 102 to the biometric information acquisition section 110. The controller 101 can control the overall operation of the image capturing apparatus 100 by reading out programs for controlling the image capturing apparatus 100 from the memory section 108 and loading part of the programs into the system memory section 107. The programs include e.g. programs for enabling the controller 101 to cause the sections and units of the image capturing apparatus 100 to operate. Further, the controller 101 can perform auto exposure (AE) control for controlling the brightness of a captured image acquired by an image capturing process performed by the image capturing section 105 and auto focus (AF) control for moving the lens to focus on an object. The power supply circuit section 102 is comprised, for example, of a battery detection circuit, a protection circuit, a DC-DC converter, and a low-dropout (LDO) regulator (none of which are shown). The power supply circuit section 102 thus formed supplies a voltage applied from the power supply section 103 to the electronic devices incorporated in the image capturing apparatus 100 after converting the voltage to a desired voltage. Further, the power supply circuit section 102 has a determination function of determining whether or not a battery is attached and determining a type of the attached battery. Further, the power supply circuit section 102 has a protection function of protecting, in a case where an abnormality, such as overcurrent, is detected, the above-mentioned electronic devices, by shutting off the power supply from the power supply section 103. Note that the power supply circuit section 102 preferably has an electric power detection circuit capable of detecting an amount of electric power supplied to the sections and units in the image capturing apparatus 100. The power supply section 103 is implemented e.g. by a secondary battery, such as a NiCd battery, a NiMH battery, or a Li battery, or by an AC adapter or the like. The power supply section 103 has means for acquiring a battery remaining amount and can notify the controller 101 of the battery remaining amount.

The display section 104 is formed by the monitor 1010, the finder 1011, and the display panel 1012. The display section 104 displays, on a screen, captured image data generated by the image capturing section 105, after visualizing the captured image data under the control of the controller 101. The visualized data is not particularly limited, and examples of the visualized data include characters, an image, and so forth. The display section 104 is formed by a combination of the EVF, a liquid crystal display (LCD), a light emitting diode (LED), and/or the like. The image capturing section 105 is comprised of an image sensor, such as a complementary metal-oxide-semiconductor (CMOS) sensor or a charge coupled device (CCD). In the image capturing section 105, an object image is formed through an optical system (not shown) including lenses. The image capturing section 105 performs the image capturing process for capturing an image, to thereby generate captured image data, and transmits the generated captured image data to the controller 101 according to the control from the controller 101. The captured image data is developed by the controller 101. Then, the captured image data is stored, after having metadata attached thereto, in the recording section 109 as an image file. Note that in a case where the captured image data is still image data, the captured image data is stored in the recording section 109 as an image file of the Joint Photographic Experts Group (JPEG) format, and in a case where the captured image data is moving image data, the captured image data is stored in the recording section 109 as an image file of the Moving Picture Experts Group (MPEG) format.

The operation section 106 is comprised of sections ranging from the main power button 1001 to the eye-contact detection section 1009. The operation section 106 thus comprised can input a variety of predetermined operation instructions to the controller 101. The release button 1002 as a component of the operation section 106 is sequentially pressed in two steps with a time difference therebetween when the photographer performs an operation of instructing shooting to the image capturing section 105. This release button 1002 is comprised of a first release switch (detection unit), a second release switch (detection unit), and a capacitance-type touch sensor, none of which are shown. When the pressing operation of the first step is performed on the release button 1002, the first release switch is turned on, and the ON-state is detected as a first operation. This ON-state is output to the controller 101 as a first operation instruction. After that, when the pressing operation of the second step, which requires a larger force than that of the pressing operation of the first step, is performed on the release button 1002, the second release switch is turned on, and the ON-state is detected as a second operation. This ON-state is output to the controller 101 as a second operation instruction. Further, in a case where the photographer touches the release button 1002 before the pressing operation is performed on the release button 1002, the touch sensor reacts, and a result of this reaction is output to the controller 101 as a third operation instruction. In the following description, the first operation instruction, the second operation instruction, and the third operation instruction are sometimes referred to as the SW1, the SW2, and the SW0. In a case where the controller 101 detects the SW0, it is grasped that the photographer is performing the shooting preparation with his/her finger placed on the release button 1002. In a case where the controller 101 detects the SW1, it is grasped that the photographer has half-pressed the release button 1002. The controller 101 performs the AF control and the AE control in this state. Further, in a case where the controller 101 detects the SW2, it is grasped that the photographer has fully-pressed the release button 1002. The controller 101 executes the image capturing process in this state.

The main power button 1001 as a component of the operation section 106 is switched between a ON-state and an OFF-state according to an operation performed by the photographer, i.e. a user operation. In a case where the main power button 1001 is switched from the OFF-state to the ON-state, the main power button 1001 outputs a camera start instruction to the controller 101. Upon receipt of the camera start instruction, the controller 101 shifts the image capturing apparatus 100 to a camera activated state. In the camera activated state, the desired voltage is applied to the electronic devices. The controller 101 performs control to enable the display section 104 to display a live view video acquired by the image capturing section 105 regardless of whether or not an input from the operation section 106 is received. This enables the photographer to perform preparation for shooting an object while confirming the live view video. Further, in a case where the main power button 1001 is switched from the ON-state to the OFF-state, the main power button 1001 outputs a camera termination instruction to the controller 101. Upon receipt of the camera termination instruction, the controller 101 shifts the image capturing apparatus 100 to a camera terminated state. In the camera terminated state, application of the voltage to the electronic devices is shut off. Further, in the camera terminated state, the electric current consumption of the image capturing apparatus 100 is the lowest.

The system memory section 107 is implemented e.g. by a random access memory (RAM), into which, for example, a program read out from the memory section 108, constants and variables for the operation of the controller 101, and so forth are loaded. Further, the system memory section 107 also functions as a buffer memory for temporarily storing captured image data (image file) acquired by the image capturing section 105 until the captured image data is finally stored in the recording section 109. The memory section 108 is implemented e.g. by an electrically erasable/recordable nonvolatile memory or a read only memory (ROM). In the memory section 108, for example, the constants, the programs, and so forth for the operation of the controller 101 are stored. The recording section 109 finally stores the captured image data (image file) differently from temporary storage in the system memory section 107. In the present embodiment, the recording section 109 can be a storage medium fixed to (incorporated in advance in) the image capturing apparatus 100, or a storage medium which is removably attached to the image capturing apparatus 100, but the recording section 109 is not limited to this. Another example of the recording section 109 can be an external device formed as a separate device from the image capturing apparatus 100 and disposed at a location different from the image capturing apparatus 100. The external apparatus is not particularly limited, and for example, a desktop-type or laptop-type personal computer, a tablet terminal, or a smartphone can be used as the external apparatus. Further, in a case where the recording section 109 is an external apparatus, the external apparatus and the image capturing apparatus 100 are communicably connected by wired or wireless connection. The biometric information acquisition section 110 acquires biometric information of the photographer. The biometric information refers to information indicating a physical feature for identifying an individual as a photographer and is used for a biometric authentication process for authenticating a photographer. The biometric information is not particularly limited, and for example, fingerprint information, face information, iris information, voiceprint information, or vein pattern information can be used as the biometric information.

The photographer as the user of the image capturing apparatus 100 stores a user database associating the biometric information of the photographer himself/herself with a legitimate user name as the photographer name, in the memory section 108 (information storage unit) in advance. When the user performs shooting using the image capturing apparatus 100, the biometric authentication process is performed based on the user database. The biometric authentication process is performed by the controller 101. Thus, in the present embodiment, the controller 101 functions as a biometric authentication unit that performs the biometric authentication process. Note that, for the image capturing apparatus 100, part which functions as the biometric authentication unit can be provided separately from the controller 101. In the biometric authentication process, the biometric information acquired by the biometric information acquisition section 110 and the biometric information stored in the user database (the memory section 108) in advance are compared to determine whether or not the pieces of the biometric information match. Then, as a result of this determination, if it is determined that the pieces of the biometric information match, it is determined that the biometric authentication process is successful. That is, it is determined that the photographer is a user having a legitimate user name of a user permitted to use the image capturing apparatus 100. Then, the legitimate user name is stored e.g. in the memory section 108 as authenticated user information in the current shooting. Further, the authenticated user information is added to an image file generated by the shooting executed in parallel with the biometric authentication process, more specifically, e.g. to a photographer tag in the Exif, as the photographer information.. The photographer information is identification information based on which a photographer can be identified. On the other hand, if it is determined that the pieces of the biometric information do not match (mismatch), it is determined that the biometric authentication process has failed (is not successful), i.e. it is determined that the photographer is not a legitimate user who is permitted to use the image capturing apparatus 100.

Note that in a case where the fingerprint information is used as the biometric information, the biometric information acquisition section 110 can be configured e.g. as a fingerprint authentication sensor embedded in the release button 1002. In the biometric authentication process in this case, the fingerprint information of a photographer operating the release button 1002 when performing shooting and the fingerprint information stored in the user database are compared to determine whether or not the pieces of the fingerprint information match. Further, in a case where the iris information is used as the biometric information, the biometric information acquisition section 110 can be configured e.g. as an iris authentication sensor mounted in the finder 11. In the biometric authentication process in this case, the iris information of a photographer who brings his/her eye into contact with the finder 11 when performing shooting and the iris information stored in the user database are compared to determine whether or not the pieces of the iris information match.

Further, it is considered that the biometric authentication process is executed not only whenever a shooting operation is performed e.g. by operating the release button 1002 or bringing a photographer’s eye into contact with the finder 11, but also only when the image capturing apparatus 100 is started. In a configuration in which the biometric authentication process is executed only when the image capturing apparatus 100 is started, for example, in a case where a photographer who has started the image capturing apparatus 100 (hereinafter referred to as the first photographer) and a photographer who performs shooting after that (hereinafter referred to as the second photographer) are different, there is a possibility that the following phenomenon occurs: There is a possibility that the authenticated user information (legitimate user name) of the first photographer, which is obtained by the biometric authentication process performed when starting the image capturing apparatus 100, can be directly added as the photographer information of the second photographer who performs shooting after that. So, in the image capturing apparatus 100, the biometric authentication process is executed whenever shooting is performed so as to make it possible to prevent such phenomenon. This makes it possible to increase the reliability of the photographer information added to the image file. Further, to guarantee the authenticity of the image file, it is preferable that the image capturing apparatus 100 performs user registration in a management server system such that an image file can be registered in a management server which is the recording section 109, by using a block chain. In this configuration, first, a hash value of an image file is generated when shooting is performed by the image capturing apparatus 100. Then, information related to the image file and the hash value are registered in the block chain as the information of the image file. With this, it is possible to guarantee the authenticity of the image file. Further, registration of an image file in the management server is permitted only in a case where the authenticated user information corresponding to a result of the biometric authentication process executed simultaneously with the shooting and the user information registered in the management server match. This makes it possible to avoid spoofing by a third party, and therefore, it is possible to increase the reliability of the image file.

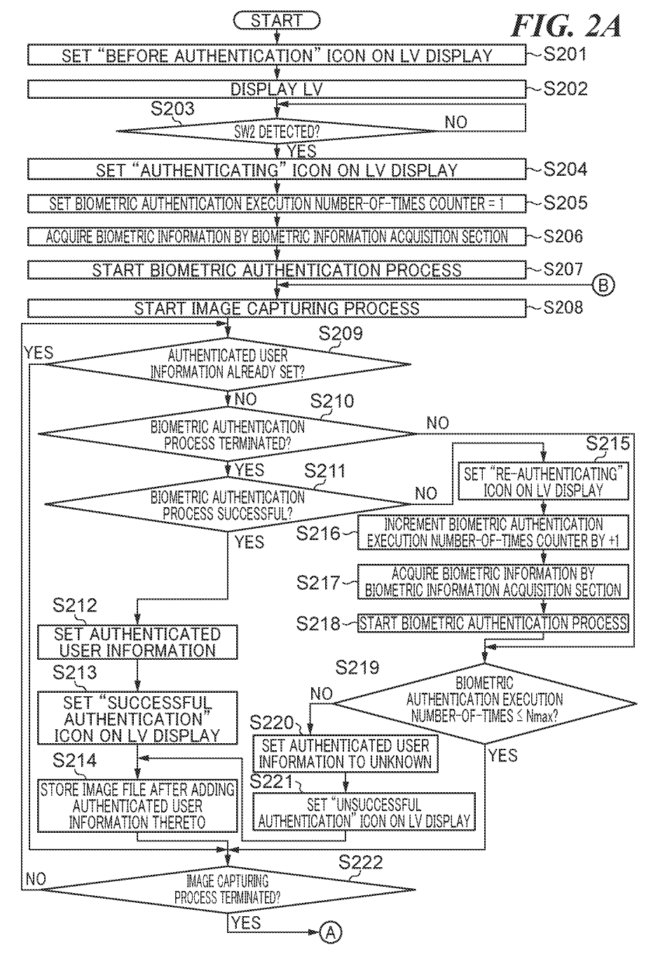

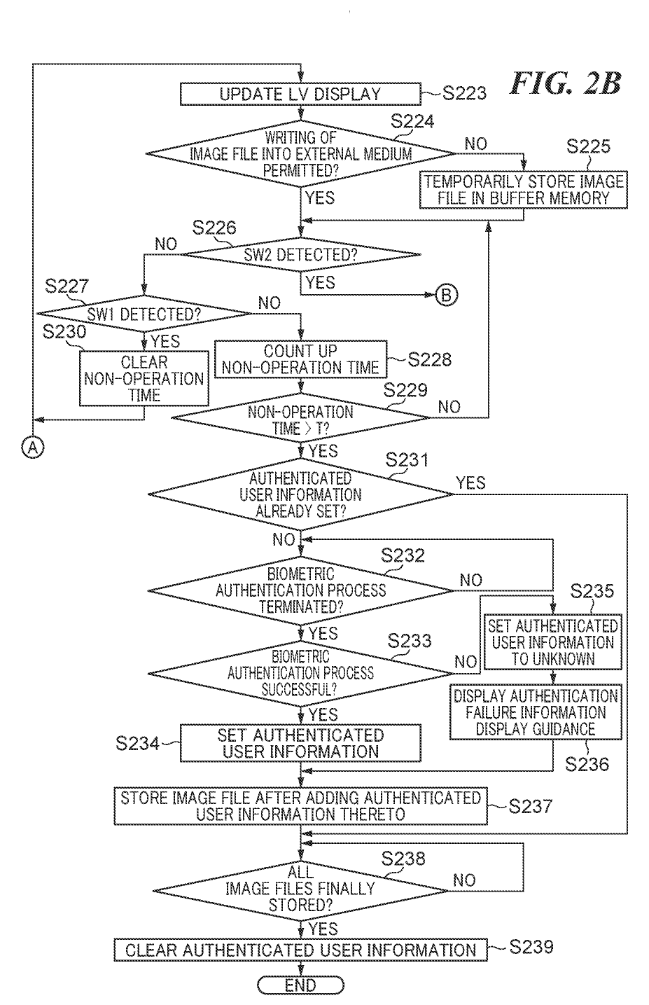

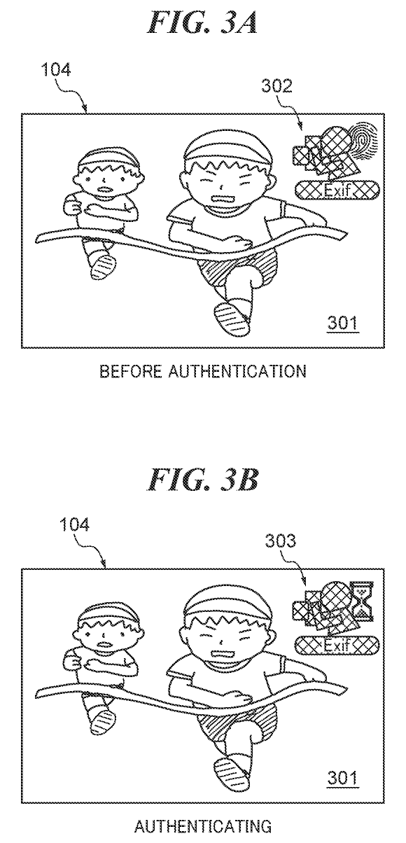

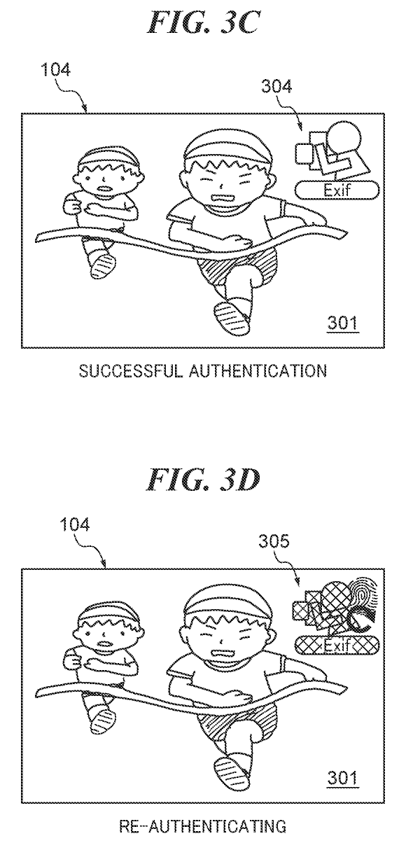

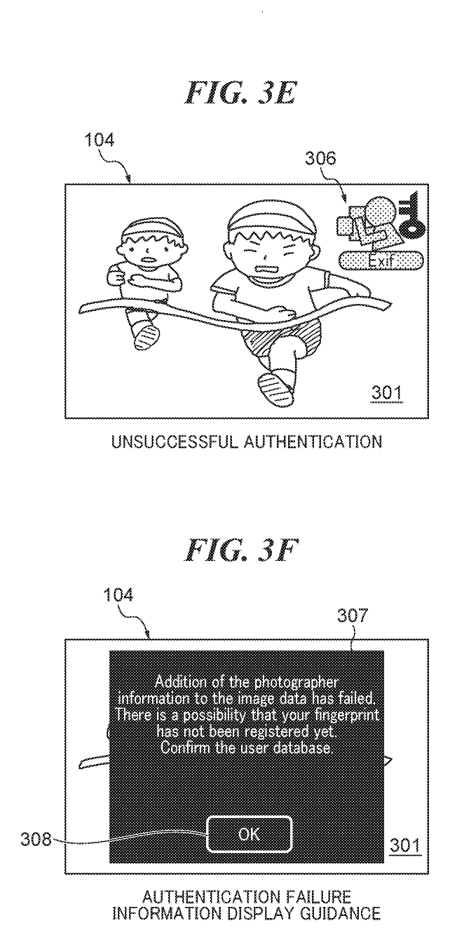

FIGS. 2A and 2B are a flowchart of a process performed by the image capturing apparatus. The program of the process shown in FIGS. 2A and 2B has been stored in the memory section 108. This program is loaded by the controller 101 into the system memory section 107 and executed by the controller 101. In a case where a camera start instruction is received from the operation section 106, the controller 101 shifts the image capturing apparatus 100 to the activated state. After that, the program of the process shown in FIGS. 2A and 2B is started. Referring to FIG. 2A, in a step S201, the controller 101 performs preparation for displaying an icon 302 (see FIG. 3A) on the display section 104, together with a live view (LV) video 301. In the present embodiment, the icon 302 is displayed in a state superimposed on the live view video 301. As described hereinafter, the icon 302 is an icon indicating a state before authentication (before the biometric authentication process) out of processing state information (status) indicating an execution state of the biometric authentication process. After execution of the step S201, the process proceeds to a step S202.

In the step S202, the controller 101 displays the live view video 301 on which the icon 302 prepared in the step S201 is superimposed, on the display section 104. After execution of the step S202, the process proceeds to a step S203.

In the step S203, the controller 101 determines whether or not the SW2 of the release button 1002 has been detected. If it is determined by the controller 101 in the step S203 that the SW2 has been detected, the process proceeds to a step S204. On the other hand, if it is determined by the controller 101 in the step S203 that the SW2 has not been detected, the process remains in the step S203.

In the step S204, the controller 101 performs preparation for displaying an icon 303 (see FIG. 3B) on the display section 104 in a state superimposed on the live view video 301. As will be described hereinafter, the icon 303 is an icon indicating an authenticating state out of the processing state information. Note that in a case of continuous still image shooting in which the SW2 is continuously detected, i.e. the ON-state is continuously detected, the live view video 301 is displayed between the operations of shooting each one frame of a still image. With this, the user can grasp the states of the object and the image capturing apparatus 100 while confirming the live view video 301 even during continuous still image shooting. After execution of the step S204, the process proceeds to a step S205.

In the step S205, the controller 101 sets a biometric authentication execution number-of-times counter to 1. The biometric authentication execution number-of-times counter refers to the number of times of execution of the biometric authentication process performed in parallel with shooting. After execution of the step S205, the process proceeds to a step S206.

In the step S206, the controller 101 controls the biometric information acquisition section 110 to acquire biometric information of the photographer (user) who performs shooting, by operating the image capturing apparatus 100. After execution of the step S206, the process proceeds to a step S207.

In the step S207, the controller 101 starts the biometric authentication process. As described hereinabove, in the biometric authentication process, the biometric information acquired by the biometric information acquisition section 110 (the step S206) and the biometric information stored in the user database are compared. Then, whether or not the biometric information acquired by the biometric information acquisition section 110 matches the biometric information stored in the user database is verified. After execution of the step S207, the process proceeds to a step S208.

In the step S208, the controller 101 controls the image capturing section 105 to start acquisition of image data by the image capturing section 105, i.e. the image capturing process. In the image capturing process, the image capturing section 105 performs photoelectric conversion and A/D conversion of an object image formed on the image sensor. Note that the image capturing process is performed without waiting for termination of the biometric authentication process. After execution of the step S208, the process proceeds to a step S209.

In the step S209, the controller 101 determines whether or not the authenticated user information has already been stored (set) in the memory section 108. If it is determined by the controller 101 in the step S209 that the authenticated user information has already been stored, the process proceeds to a step S222. On the other hand, if it is determined by the controller 101 in the step S209 that the authenticated user information has not been stored yet, the process proceeds to a step S210.

In the step S210, the controller 101 determines whether or not the biometric authentication process has been terminated. If it is determined by the controller 101 in the step S210 that the biometric authentication process has been terminated, the process proceeds to a step S211. On the other hand, if it is determined by the controller 101 in the step S210 that the biometric authentication process has not been terminated, the process proceeds to a step S219.

In the step S211, the controller 101 determines whether or not the biometric authentication process is successful as a result of the biometric authentication process terminated in the step S210. This determination is performed, by comparing the biometric information acquired by the biometric information acquisition section 110 and the biometric information stored in the user database, and based on whether or not the two pieces of the biometric information match. In a case where the two pieces of the biometric information match, it is determined that the biometric authentication process is successful. On the other hand, in a case where the two pieces of the biometric information do not match, it is determined that the biometric authentication process has failed. As described above, the photographer as the user of the image capturing apparatus 100 has already stored the user database in which the biometric information of the photographer himself/herself is associated with the legitimate user name which is the photographer name, in the memory section 108 in advance. In a case where this user database has not been stored, it is determined that the biometric authentication process has failed. In a case where the biometric information acquisition section 110 is the fingerprint authentication sensor embedded in the release button 1002, when the photographer wearing gloves operates the release button 1002, there is a possibility that it is also determined that the biometric authentication process has failed. Further, depending on a position of the fingertip with respect to the release button 1002, it is difficult to accurately read the fingerprint, so that there is a possibility that it is determined that the biometric authentication process has failed. Further, in a case where the fingertip operating the release button 1002 is dirty, there is a possibility that it is determined that the biometric authentication process has failed. Then, if it is determined by the controller 101 in the step S211 that the biometric authentication process is successful, the process proceeds to a step S212. On the other hand, if it is determined by the controller 101 in the step S211 that the biometric authentication process has failed, the process proceeds to a step S215.

In the step S212, the controller 101 determines a legitimate user name of the photographer as a photographer who is permitted to use the image capturing apparatus 100, as the authenticated user information, in the memory section 108. After execution of the step S212, the process proceeds to a step S213.

In the step S213, the controller 101 performs preparation for displaying an icon 304 (see FIG. 3C) on the display section 104 in a state superimposed on the live view video 301. As described hereinafter, the icon 304 is an icon indicating a state of successful authentication out of the processing state information. After execution of the step S213, the process proceeds to a step S214.

In the step S214, the controller 101 provides permission of writing the image file acquired (generated) by the image capturing process into an external medium. Further, the image file has been temporarily stored in the buffer memory in the system memory section 107, and after providing the permission of writing the image file into the external medium, the authenticated user information is added to the image file by the controller 101. After that, the image file to which the authenticated user information has been added is transferred to the recording section 109 and finally stored therein. Further, in a case where the biometric authentication process has been terminated, the controller 101 similarly adds the authenticated user information also to an image file acquired by the image capturing process after the biometric authentication process has been terminated and stores the image file in the recording section 109. After execution of the step S214, the process proceeds to the step S222.

In the step S215 after execution of the step S211, the controller 101 performs preparation for displaying an icon 305 (see FIG. 3D) on the display section 104 in a state superimposed on the live view video 301. As will be described hereinafter, the icon 305 indicates a re-authenticating state out of the processing state information. After execution of the step S215, the process proceeds to a step S216.

In the step S216, the controller 101 increments the biometric authentication execution number-of-times counter by +1. After execution of the step S216, the process proceeds to a step S217.

Similar to the step S206, in the step S217, the controller 101 controls the biometric information acquisition section 110 to acquire the biometric information of the photographer who performs shooting by operating the image capturing apparatus 100. After execution of the step S217, the process proceeds to a step S218.

Similar to the step S207, in the step S218, the controller 101 starts the biometric authentication process. After execution of the step S218, the process proceeds to the step S219.

In the step S219, the controller 101 determines whether or not the biometric authentication execution number-of-times counter is not larger than a threshold value Nmax. Note that the threshold value Nmax is the maximum number of times of execution of the biometric authentication process, which is permitted to be executed in one time of the image capturing process, and has been included in the program of the process shown in FIGS. 2A and 2B, in advance. If it is determined in the step S211 that the biometric authentication process has failed, the process repeatedly executes the steps S217 and S218 until the biometric authentication execution number-of-times counter exceeds the threshold value Nmax. With this, even in a case where the biometric authentication process has continuously failed until the biometric authentication execution number-of-times counter exceeds the threshold value Nmax, it is possible to increase the possibility that the biometric authentication process finally succeeds. Further, in the image capturing apparatus 100, it is preferable to set the upper limit number of times in a case where the biometric authentication process is repeatedly executed. For example, in a case where the user database in which the biometric information of the photographer himself/herself is associated with the legitimate user name has not been stored in the memory section 108 yet, even when the biometric authentication process is repeatedly executed, the biometric authentication process finally fails. Therefore, by setting the upper limit number of times in the case where the biometric authentication process is executed again, it is possible to prevent the biometric authentication process from being wastefully repeated. Then, if it is determined by the controller 101 in the step S219 that the biometric authentication execution number-of-times counter is not larger than the threshold value Nmax, the process proceeds to the step S222. On the other hand, if it is determined by the controller 101 in the step S219 that the biometric authentication execution number-of-times counter is larger than the threshold value Nmax, the process proceeds to a step S220.

In the step S220, the controller 101 stores “Unknown”, which indicates that the photographer is an unidentified photographer who has not been registered in the user database, in the memory section 108, as the authenticated user information, i.e. sets “Unknown” in the authenticated user information. After execution of the step S220, the process proceeds to a step S221.

In the step S221, the controller 101 performs preparation for displaying an icon 306 (see FIG. 3E) on the display section 104 in a state superimposed on the live view video 301. As will be described hereinafter, the icon 306 indicates a state of unsuccessful authentication out of the processing state information. After execution of the step S221, the process proceeds to the step S214.

In the step S222, the controller 101 determines whether or not the image capturing process has been terminated. This determination is performed based on completion of development processing. In a case where the development processing has been completed, it is determined that the image capturing process has been terminated. On the other hand, in a case where the development processing has not been completed, it is determined that the image capturing process has not been terminated. Note that the determination in the step S222 can be performed based on completion of acquisition of image data from the image capturing section 105. Then, if it is determined by the controller 101 in the step S222 that the image capturing process has been terminated, the process proceeds to a step S223 in FIG. 2B. On the other hand, if it is determined by the controller 101 in the step S222 that the image capturing process has not been terminated, the process returns to the step S209, and the step S209 et seq. are sequentially executed.

In the step S223, the controller 101 updates the live view video 301 displayed on the display section 104. Further, one of the icons prepared in the steps S204, S213, S215, and S221 is displayed in the state superimposed on the live view video 301. This enables the photographer to confirm not only the object, but also the processing state of the biometric authentication process. After execution of the step S223, the process proceeds to a step S224.

In the step S224, the controller 101 determines whether or not writing of the image file into the external medium is permitted. If it is determined by the controller 101 in the step S224 that writing of the image file is permitted, the process proceeds to a step S226. On the other hand, if it is determined by the controller 101 in the step S224 that writing of the image file is not permitted, the process proceeds to a step S225.

In the step S225, the controller 101 temporarily stores the image file, about which it is determined in the step S222 that the image capturing process has been terminated, in the buffer memory in the system memory section 107. After execution of the step S225, the process proceeds to the step S226.

Similar to the step S203, in the step S226, the controller 101 determines whether or not the SW2 of the release button 1002 has been detected. If it is determined by the controller 101 in the step S226 that the SW2 has been detected, the process returns to the step S208, and the step S208 et seq. are sequentially executed. On the other hand, if it is determined by the controller 101 in the step S226 that the SW2 has not been detected, the process proceeds to a step S227.

In the step S227, the controller 101 determines whether or not the SW1 of the release button 1002 has been detected. If it is determined by the controller 101 in the step S227 that the SW1 has been detected, the process proceeds to a step S230. On the other hand, if it is determined by the controller 101 in the step S227 that the SW1 has not been detected, the process proceeds to a step S228.

In the step S228, the controller 101 counts up a non-operation time period. The non-operation time period refers to a time period during which the SW1 is not detected. In a state in which the SW1 is not detected, it is possible to regard that the photographer is not performing the shooting operation. After execution of the step S228, the process proceeds to a step S229.

In the step S229, the controller 101 determines whether or not the non-operation time period has exceeded a predetermined time period (threshold) T. As the predetermined time period T, a time period during which the photographer temporarily releases the fingertip from the SW1 is set. If the fingertip is temporarily released, it is possible to omit the biometric authentication process after this release and reduce the processing load e.g. of the controller 101. For example, in a case where the predetermined time period T is set to a relatively long time period and the first photographer and the second photographer are different, there is a possibility that the authenticated user information of the first photographer is directly added as the photographer information of the second photographer. To avoid this, the predetermined time period T is preferably set to a time period shorter than a time period to elapse, after the first photographer input the SW1 last time as the second photographer, until the second photographer, who is changed, inputs the SW1 for the first time. For example, actually, it is difficult to imagine that the first photographer inputs the SW1 last time, and then the second photographer inputs the SW1 within two seconds after the image capturing apparatus 100 is passed from the first photographer to the second photographer. Based on such an imagination, the predetermined time period T is set to two seconds. Further, the predetermined time period T is incorporated in the program of the process shown in FIGS. 2A and 2B in advance. Then, if it is determined by the controller 101 in the step S229 that the non-operation time period has exceeded the predetermined time period T, the process proceeds to a step S231. On the other hand, if it is determined by the controller 101 in the step S229 that the non-operation time period has not exceeded the predetermined time period T, the process returns to the step S226, and the step S226 et seq. are sequentially executed.

In the step S230, the controller 101 clears the non-operation time period. After execution of the step S230, the process returns to the step S226, and the step S226 et seq. are sequentially executed.

Similar to the step S209, in the step S231, the controller 101 determines whether or not the authenticated user information has already been set, i.e. stored in the memory section 108. If it is determined by the controller 101 in the step S231 that the authenticated user information has already been stored, the process proceeds to a step S238. On the other hand, if it is determined by the controller 101 in the step S231 that the authenticated user information has not been stored yet, the process proceeds to a step S232.

Similar to the step S210, in the step S232, the controller 101 determines whether or not the biometric authentication process has been terminated. If it is determined by the controller 101 in the step S232 that the biometric authentication process has been terminated, the process proceeds to a step S233. On the other hand, if it is determined by the controller 101 in the step S232 that the biometric authentication process has not been terminated, the process remains in the step S232.

Similar to the step S211, in the step S233, the controller 101 determines whether or not the biometric authentication process, which is determined in the step S232 as terminated, is successful. If it is determined by the controller 101 in the step S233 that the biometric authentication process is successful, the process proceeds to a step S234. On the other hand, if it is determined by the controller 101 in the step S232 that the biometric authentication process has failed, the process proceeds to a step S235.

Similar to the step S212, in the step S234, the controller 101 stores a legitimate user name which is the name of a photographer who is permitted to use the image capturing apparatus 100, as the authenticated user information, in the memory section 108. After execution of the step S234, the process proceeds to a step S237.

Similar to the step S220, in the step S235, the controller 101 stores “Unknown”, which indicates that the photographer is an unidentified photographer who has not been registered in the user database, in the memory section 108, as the authenticated user information, i.e. sets “Unknown” in the authenticated user information. After execution of the step S235, the process proceeds to a step S236.

In the step S236, the controller 101 displays an authentication failure information display guidance 307 (see FIG. 3F) on the display section 104 in a state superimposed on the live view video 301. Execution of the step S236 means that the biometric authentication process, which has been started in accordance with detection of the SW2 in the step S203, has failed. Therefore, it is possible to consider that, for the photographer, the photographer information of the image file acquired by the image capturing apparatus 100 has not been added as intended. Then, by displaying the authentication failure information display guidance 307 on the display section 104 in the step S236, the photographer can grasp that the biometric authentication process has failed. For example, in a case where the operation of storing the user database has not been performed yet, the photographer can perform the operation of storing the user database at a time when the photographer visually recognizes the authentication failure information display guidance 307. This makes it possible to prevent the failure in the biometric authentication process from being caused due to non-execution of the operation of storing the user database. Further, in a case where the biometric information acquisition section 110 is the fingerprint authentication sensor, if the photographer is about to operate the release button 1002 in a state wearing a glove, the photographer can take off the glove and operate the release button 1002 at a time when the photographer visually recognizes the authentication failure information display guidance 307. After execution of the step S236, the process proceeds to the step S237.

Similar to the step S214, in the step S237, the controller 101 finally stores the image file to which the authenticated user information has been added, in the recording section 109. After execution of the step S237, the process proceeds to the step S238.

In the step S238, the controller 101 determines whether or not all of the image files temporarily stored in the buffer memory in the system memory section 107 have been finally stored in the recording section 109. This determination is performed based on whether or not the buffer memory is in an empty state. In a case where the buffer memory is in the empty state, it is determined that all of the image files have been finally stored in the recording section 109. On the other hand, in a case where the buffer memory is not in the empty state, it is determined that not all of the image files have been finally stored in the recording section 109. Then, if it is determined by the controller 101 in the step S238 that all of the image files have been finally stored in the recording section 109, the process proceeds to a step S239. On the other hand, if it is determined by the controller 101 in the step S238 that not all of the image files have been finally stored in the recording section 109, the process remains in the S238.

In the step S239, the controller 101 clears the authenticated user information stored in the memory section 108, followed by terminating the present process.

In the above-described control, the operation of starting the image capturing process (step S208) is executed before the biometric authentication process started by the operation of starting the biometric authentication process (step S207) is terminated. In general, the biometric authentication process takes approximately 300 to 500 ms, and hence if execution of the operation of starting the image capturing process is delayed until the biometric authentication process is terminated, the start of the image capturing process is delayed by a time period required to perform the biometric authentication process. In this case, a desired shooting timing can be lost. Therefore, by executing the operation of starting the image capturing process before the biometric authentication process is terminated, it is possible to prevent the desired shooting timing from being lost. Further, in a case where the biometric authentication process has been started in accordance with the start of the image capturing process as described above, but after that, the biometric authentication process has not been terminated before termination of the image capturing process, the image file generated by the image capturing process is temporarily stored in the system memory section 107 (step S225). This makes it possible to reduce a situation where the time required to perform the biometric authentication process affects the image capturing process, i.e. a situation where the start of the image capturing process is delayed, and a desired shooting timing is lost. Further, it is possible to prevent an image file to which the photographer information has not been added yet from being finally stored in the recording section 109. Then, in a case where the biometric authentication process is terminated after temporarily storing the image file in the system memory section 107, the photographer information (result of the biometric authentication process) is added to the image file temporarily stored in the system memory section 107, and the image file is finally stored in the recording section 109 (step S238). With this, it is possible to obtain the image file having the photographer information which is high in reliability, i.e. the image file acquired by the operation performed by the legitimate photographer.

Although in the image capturing apparatus 100, the first operation is detected based on the pressing operation of the first step, which is performed on the release button 1002, and then, the second operation is detected based on the pressing operation of the second step, which is performed on the release button 1002, this is not limitative. For example, a contact (SW0) of the photographer on the release button 1002 can be detected as the first operation, and an operation of pressing the release button 1002 (SW1 or SW2), which is performed by the photographer, can be detected as the second operation.

Further, an operation of holding the grip part 120 can be detected as the first operation, and the operation of pressing the release button 1002 can be detected as the second operation. Further, an operation of bringing an eye into contact with the finder 101 can be detected as the first operation, and the operation of pressing the release button 1002 can be detected as the second operation. Then, in a case where the first operation is detected, the controller 101 is caused to perform the biometric authentication process, and if the biometric authentication process is successful, it is preferable to add, before the first operation is detected again, information that the biometric authentication process is successful to generated image files. This control is hereinafter referred to as the “post-operation detection authentication processing”. For example, in a case where the biometric authentication process is executed whenever shooting is performed even though the photographer is the same, this biometric authentication process can be unnecessary biometric authentication process. In view of this, by performing the post-operation detection authentication processing, it is possible to omit the unnecessary biometric authentication process. Note that as the information that the biometric authentication process is successful, for example, the photographer information can be added.

Further, in a case where the biometric authentication process has never been successful, Unknown is stored as the authenticated user information, and then writing of the image file into an external medium is permitted (steps S220 and S235). With this, even when the biometric authentication process has failed, eventually, the image file in the buffer memory of the system memory section 107 is prevented from being deleted and is finally stored in the recording section 109. Further, the photographer can grasp that the image file is an image file in a state in which the biometric authentication process has failed, by confirming that the authenticated user information is Unknown. Further, the process shifts to the processing for counting up the non-operation time period (step S208) after the processing for determining whether or not the SW2 has been detected (step S226), in a case where the SW2 or the SW1 is input after termination of the image capturing process (step S222) and the SW2 is detected again. The process proceeds from the step S226 to the step S208 also in a case where after termination of the image capturing process (step S222), the non-operation time period is not longer than the predetermined time period T and the SW2 is detected. In these cases, it is possible to regard that the photographer operating the image capturing apparatus 100 has not been changed. With this, the process can proceed to the operation of starting the image capturing process (step S208) without executing the operation of acquiring the biometric information (step S206) and the operation of starting the biometric authentication process (step S207). Further, in a case where the authentication information has been stored at a time of determination of whether or not the SW2 has been detected (step S226), shooting is performed in a state in which the last authentication information has been stored and not changed, without executing the biometric authentication process at the time of shooting started next. Thus, in the continuous shooting, the biometric authentication process is omitted, and the same photographer information is added to a plurality of image files. This makes it possible to reduce the load of the biometric authentication process of the controller 101. Note that the biometric authentication process can be performed at each shooting time.

Further, the determination of whether or not the SW1 has been detected (step S227) can be replaced e.g. by determination of whether or not the SW0 has been detected, determination using a signal output from the eye-contact detection section 1009, or determination of whether or not the grip part 120 of the image capturing apparatus 100 is being held by the photographer. Note that the determination of whether or not the grip part 120 is being held can be performed by providing a capacitance-type or pressure detection-type gripping detection device in the operation section 106. Further, in a case where it is determined that the biometric authentication process has failed in the determination of whether or not the biometric authentication process is successful (step S211), the operation of acquiring the biometric information (step S217) and the operation of starting the biometric authentication process (step S218) can be continuously executed but can be executed after the lapse of a predetermined time period. This is because, by displaying the icon 305 (step S215), the photographer can take a countermeasure, such as an operation of changing the method of contact to the biometric information acquisition section 110. With this, it is possible to increase the success rate of the biometric authentication process performed by acquiring the biometric information (step S217) and starting the biometric authentication process (step S218).

FIGS. 3A to 3F are diagrams each showing an example of a screen displayed on the display section of the image capturing apparatus. Here, let it be assumed that the biometric information acquisition section 110 is the fingerprint authentication sensor embedded in the release button 1002. Referring to FIG. 3A, the live view video 301 and the icon 302 superimposed on the live view video 301 are displayed on the display section 104. The icon 302 indicates the state before authentication out of the processing state information indicating an execution state of the biometric authentication process. By visually recognizing the icon 302, the photographer can grasp that the biometric authentication process has not been executed yet, and the biometric authentication process can be executed by inputting the SW2. For example, in a case where a time period during which the photographer touches the release button 1002 when the SW2 is input is very short, the fingerprint cannot be sufficiently read by the biometric information acquisition section 110 (fingerprint authentication sensor), and the biometric authentication process can fail. In this case, by notifying the photographer of the state before authentication, using the icon 302, the photographer can increase the awareness of bringing his/her finger into contact with the release button 1002 to such a degree as will enable the biometric information acquisition section 110 to sufficiently read the fingerprint.

Referring to FIG. 3B, the live view video 301 and the icon 303 superimposed on the live view video 301 are displayed on the display section 104. The icon 303 indicates the authenticating state out of the processing state information. This enables the photographer to grasp that the first biometric authentication process is being executed and have intention of continuing to keep his/her finger in contact with the release button 1002.

Referring to FIG. 3C, the live view video 301 and the icon 304 superimposed on the live view video 301 are displayed on the display section 104. The icon 304 indicates the state of successful authentication out of the processing state information. This enables the photographer to grasp, after termination of the biometric authentication process, that the biometric authentication process is successful.

Referring to FIG. 3D, the live view video 301 and the icon 305 superimposed on the live view video 301 are displayed on the display section 104. The icon 305 indicates the re-authenticating state out of the processing state information. This enables the photographer to grasp that the biometric authentication process has once failed and then is being executed again. For example, depending on a position of the photographer’s fingertip with respect to the release button 1002, the fingerprint cannot be sufficiently read by the biometric information acquisition section 110, and the biometric authentication process can fail. The photographer intends to prevent repetition of this failure and corrects the position of his/her fingertip with respect to the release button 1002. After that, in a case where the biometric authentication process is executed, and the icon 305 is displayed, the photographer can grasp that the biometric authentication process is being executed again.

Referring to FIG. 3E, the live view video 301 and the icon 306 superimposed on the live view video 301 are displayed on the display section 104. The icon 306 indicates the state of unsuccessful authentication out of the processing state information. This enables the photographer to grasp, after termination of the biometric authentication process, that the biometric authentication process has failed, and the photographer information is not added to the image file as desired by the photographer. In this case, the photographer can correct the position of his/her fingertip with respect to the release button 1002 so as to eliminate the cause of the failure of the biometric authentication process, i.e. to make the biometric authentication process successful.

Referring to FIG. 3F, the live view video 301 and the authentication failure information display guidance 307 superimposed on the live view video 301 are displayed on the display section 104. The authentication failure information display guidance 307 includes e.g. a message (information) that the photographer information is not added to the image file (due to failure in the biometric authentication process) and there is a possibility that the operation of registering the authenticated user information in the user database has not been performed yet. Further, the authentication failure information display guidance 307 includes an OK button 308. By operating the OK button 308, it is possible to hide the authentication failure information display guidance 307. Note that although each icon indicating the processing state information is displayed in the state superimposed on the live view video 301 in the present embodiment, this is not limitative, but the icon can be displayed in a state visually recognizable by the photographer. For example, the icon indicating the processing state information can be displayed in a state superimposed on a reproduced image. Further, the icon indicating the processing state information is displayed not only on the display section 104, but, for example, can be displayed on an external display communicably connected to the image capturing apparatus 100.

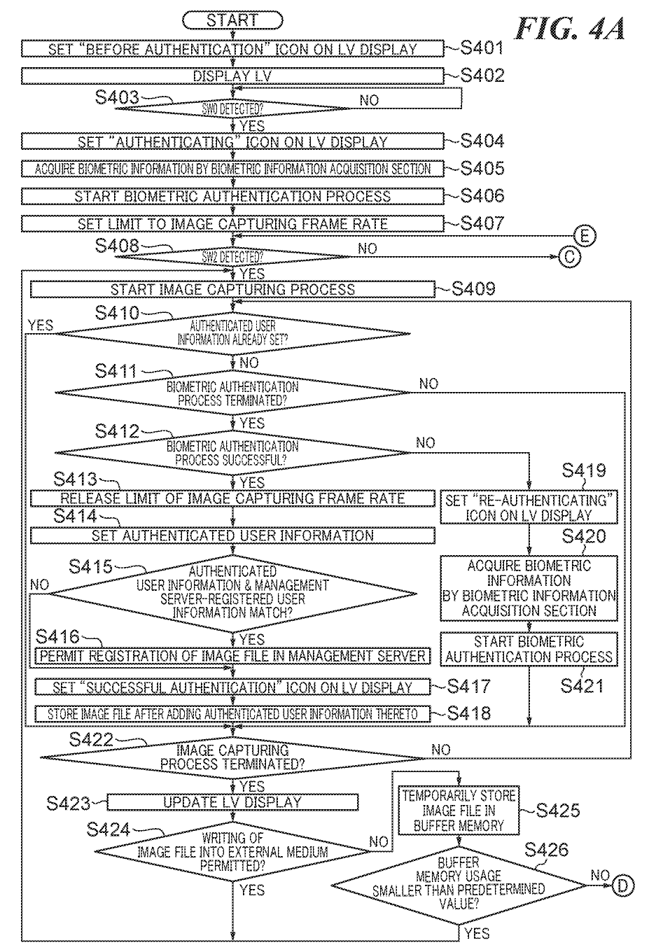

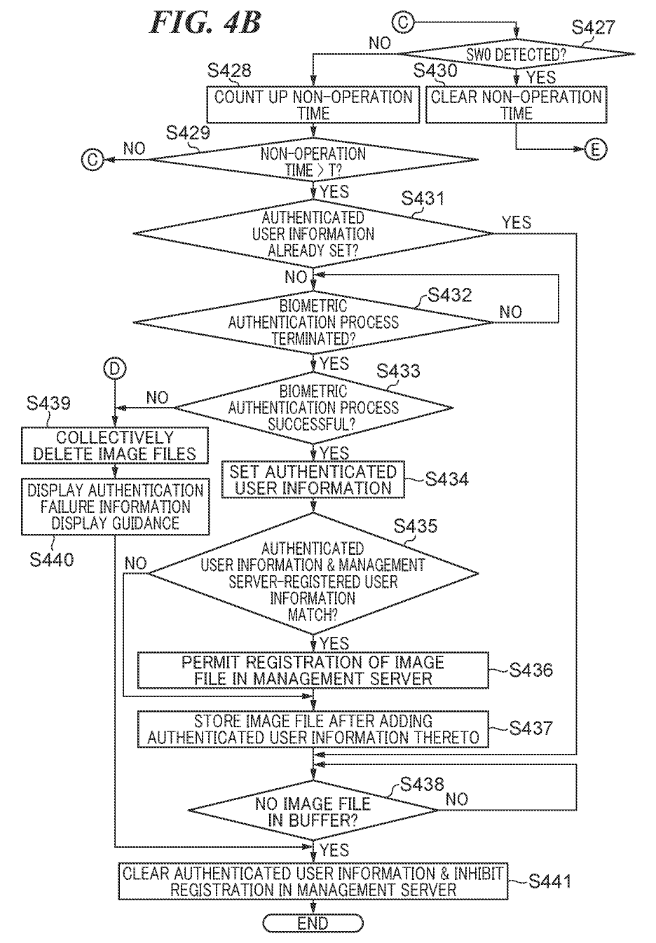

A second embodiment will be described below with reference to FIGS. 4A and 4B, but the description will be given mainly of a different point from the above-described embodiment, and description of the same points is omitted. The present embodiment is the same as the first embodiment except that in a case where the authenticated user information and the management server-registered user information which has been registered in the management server (recording section 109) match, the image file is permitted to be stored in the management server. Further, in the present embodiment, determination of whether or not to terminate the biometric authentication process in a case where the biometric authentication process has failed and is repeatedly executed is performed according to the buffer memory usage in the system memory section. FIGS. 4A and 4B are a flowchart of a process performed by the image capturing apparatus according to the second embodiment. Referring to FIG. 4A, similar to the step S201 of the program shown in FIGS. 2A and 2B, in a step S401, the controller 101 performs preparation for displaying the icon 302 on the display section 104 in the state superimposed on the live view video 301. After execution of the step S401, the process proceeds to a step S402.

Similar to the step S202, in the step S402, the controller 101 displays the live view video 301, on which the icon 302 prepared in the step S401 is superimposed, on the display section 104. After execution of the step S402, the process proceeds to a step S403.

In the step S403, the controller 101 determines whether or not the SW0 of the release button 1002 has been detected. If it is determined by the controller 101 in the step S403 that the SW0 has been detected, the process proceeds to a step S404. On the other hand, if it is determined by the controller 101 in the step S403 that the SW0 has not been detected, the process remains in the step S403.

Similar to the step S204, in the step S404, the controller 101 performs preparation for displaying the icon 303 on the display section 104 in the state superimposed on the live view video 301. After execution of the step S404, the process proceeds to a step S405.

Similar to the step S206, in the step S405, the controller 101 controls the biometric information acquisition section 110 to acquire the biometric information of the photographer who performs shooting by operating the image capturing apparatus 100. After execution of the step S405, the process proceeds to a step S406.

Similar to the step S207, in the step S406, the controller 101 starts the biometric authentication process. After execution of the step S406, the process proceeds to a step S407.

In the step S407, the controller 101 performs control to limit the image capturing frame rate. The image capturing frame rate refers to the number of still images which can be continuously photographed per unit time in the image capturing process. Further, the control to limit the image capturing frame rate refers to control to reduce the number of still images to be photographed to less than a predetermined number. With this control, it is possible to reduce usage of the buffer memory in the system memory section 107. After execution of the step S407, the process proceeds to a step S408.

Similar to the step S203, in the step S408, the controller 101 determines whether or not the SW2 of the release button 1002 has been detected. If it is determined by the controller 101 in the step S408 that the SW2 has been detected, the process proceeds to a step S409. On the other hand, if it is determined by the controller 101 in the step S408 that the SW2 has not been detected, the process proceeds to a step S427 in FIG. 4B.

Similar to the step S208, in the step S409, the controller 101 controls the image capturing section 105 to start the image capturing process. After execution of the step S409, the process proceeds to a step S410.

Similar to the step S209, in the step S410, the controller 101 determines whether or not the authenticated user information has already been stored in the memory section 108. If it is determined by the controller 101 in the step S410 that the authenticated user information has already been stored, the process proceeds to a step S422. On the other hand, if it is determined by the controller 101 in the step S410 that the authenticated user information has not been stored yet, the process proceeds to a step S411.

Similar to the step S210, in the step S411, the controller 101 determines whether or not the biometric authentication process has been terminated. If it is determined by the controller 101 in the step S411 that the biometric authentication process has been terminated, the process proceeds to a step S412. On the other hand, if it is determined by the controller 101 in the step S411 that the biometric authentication process has not been terminated, the process proceeds to the step S422.

Similar to the step S211, in the step S412, the controller 101 determines whether or not the biometric authentication process is successful as a result of the biometric authentication process terminated in the step S411. If it is determined by the controller 101 in the step S412 that the biometric authentication process is successful, the process proceeds to a step S413. On the other hand, if it is determined by the controller 101 in the step S412 that the biometric authentication process has failed, the process proceeds to a step S419.

In the step S413, the controller 101 releases the control to limit the image capturing frame rate, which is performed in the step S407. With this, in the image capturing apparatus 100, the image capturing process according to the image capturing frame rate set in advance is executed. After execution of the step S413, the process proceeds to a step S414.

Similar to the step S212, in the step S414, the controller 101 stores the legitimate user name which is the photographer name in the memory section 108 as the authenticated user information. After execution of the step S414, the process proceeds to a step S415.

In the step S415, the controller 101 determines whether or not the authenticated user information stored in the step S414 and the management server-registered user information registered in the management server match. If it is determined by the controller 101 in the step S415 that the two pieces of the information match, the process proceeds to a step S416. On the other hand, if it is determined by the controller 101 in the step S415 that the two pieces of the information do not match, the process proceeds to a step S417.

In the step S416, the controller 101 permits to store (register) the image file (captured image) in the management server. After execution of the step S416, the process proceeds to the step S417.

similar to the step S213, in the step S417, the controller 101 performs preparation for displaying the icon 304 on the display section 104 in the state superimposed on the live view video 301. After execution of the step S417, the process proceeds to a step S418.

Similar to the step S214, in the step S418, the controller 101 finally stores the image file to which the authenticated user information has been added, in the management server. After execution of the step S418, the process proceeds to the step S422.

Similar to the step S215, in the step S419 after execution of the step S412, the controller 101 performs preparation for displaying the icon 305 on the display section 104 in the state superimposed on the live view video 301. After execution of the step S419, the process proceeds to a step S420.

Similar to the step S206, in the step S420, the controller 101 controls the biometric information acquisition section 110 to acquire the biometric information of the photographer who performs shooting by operating the image capturing apparatus 100. After execution of the step S420, the process proceeds to a step S421.

Similar to the step S207, in the step S421, the controller 101 starts the biometric authentication process. After execution of the step S421, the process proceeds to the step S422.

Similar to the step S222, in the step S422, the controller 101 determines whether or not the image capturing process has been terminated. If it is determined by the controller 101 in the step S422 that the image capturing process has been terminated, the process proceeds to a step S423. On the other hand, if it is determined by the controller 101 in the step S422 that the image capturing process has not been terminated, the process returns to the step S410, and the step S410 et seq. are sequentially executed.

Similar to the step S223, in the step S423, the controller 101 updates the live view video 301 displayed on the display section 104. After execution of the step S423, the process proceeds to a step S424.

Similar to the step S224, in the step S424, the controller 101 determines whether or not writing of the image file into the external medium is permitted.

If it is determined by the controller 101 in the step S424 that writing of the image file into the external medium is permitted, the process returns to the step S408, and the step S408 et seq. are sequentially executed. On the other hand, if it is determined by the controller 101 in the step S424 that writing of the image file into the external medium is not permitted, the process proceeds to a step S425.

Similar to the step S225, in the step S425, the controller 101 temporarily stores the image file, on which it is determined in the step S422 that the image capturing process has been terminated, in the buffer memory in the system memory section 107. After execution of the step S425, the process proceeds to a step S426.

In the step S426, the controller 101 determines whether or not a buffer memory usage of the system memory section 107 is smaller than a predetermined value. The buffer memory usage refers to a ratio of capacity used to store the image file acquired through the final shooting to the total capacity of the buffer memory of the system memory section 107. Note that it is preferable that the predetermined value used as a determination criterion in the step S426 can be set as appropriate. If it is determined by the controller 101 in the step S426 that the buffer memory usage is smaller than the predetermined value, the process returns to the step S408, and the step S408 et seq. are executed. On the other hand, if it is determined by the controller 101 in the step S426 that the buffer memory usage of the system memory section 107 is not smaller than the predetermined value, i.e. equal to or larger than the predetermined value, the process proceeds to a step S439.

Similar to the step S403, in the step S427 in FIG. 4B, the controller 101 determines whether or not the SW0 has been detected. If it is determined by the controller 101 in the step S427 that the SW0 has been detected, the process proceeds to a step S430. On the other hand, if it is determined by the controller 101 in the step S427 that the SW0 has not been detected, the process proceeds to a step S428.

Similar to the step S228, in the step S428, the controller 101 counts up the non-operation time period. After execution of the step S428, the process proceeds to a step S429.

Similar to the step S229, in the step S429, the controller 101 determines whether or not the non-operation time period has exceeded the predetermined time period T. If it is determined by the controller 101 in the step S429 that the non-operation time period has exceeded the predetermined time period T, the process proceeds to a step S431. On the other hand, if it is determined by the controller 101 in the step S429 that the non-operation time period has not exceeded the predetermined time period T, the process returns to the step S427, and the step S427 et seq. are sequentially executed.

Similar to the step S230, in the step S430, the controller 101 clears the non-operation time period. After execution of the step S430, the process returns to the step S408, and the step S408 et seq. are sequentially executed.

Similar to the step S209, in the step S431, the controller 101 determines whether or not the authenticated user information has already been stored in the memory section 108. If it is determined by the controller 101 in the step S431 that the authenticated user information has already been stored, the process proceeds to a step S438. On the other hand, if it is determined by the controller 101 in the step S431 that the authenticated user information has not been stored yet, the process proceeds to a step S432.

Similar to the step S210, in the step S432, the controller 101 determines whether or not the biometric authentication process has been terminated. If it is determined by the controller 101 in the step S432 that the biometric authentication process has been terminated, the process proceeds to a step S433. On the other hand, if it is determined by the controller 101 in the step S432 that the biometric authentication process has not been terminated, the process remains in the step S432.

Similar to the step S211, in the step S433, the controller 101 determines whether or not the biometric authentication process is successful as a result of the biometric authentication process terminated in the step S432. If it is determined by the controller 101 in the step S433 that the biometric authentication process is successful, the process proceeds to a step S434. On the other hand, if it is determined by the controller 101 in the step S433 that the biometric authentication process has failed, the process proceeds to the step S439.

Similar to the step S212, in the step S434, the controller 101 stores the legitimate user name which is the photographer name of the photographer who is permitted to use the image capturing apparatus 100, in the memory section 108 as the authenticated user information. After execution of the step S434, the process proceeds to a step S435.

Similar to the step S415, in the step S435, the controller 101 determines whether or not the authenticated user information stored in the step S434 and the management server-registered user information registered in the management server match. If it is determined by the controller 101 in the step S435 that the two pieces of the information match, the process proceeds to a step S436. On the other hand, if it is determined by the controller 101 in the step S435 that the two pieces of the information do not match, the process proceeds to a step S437.

Similar to the step S416, in the step S436, the controller 101 permits to store the image file in the management server. After execution of the step S436, the process proceeds to the step S437.

Similar to the step S214, in the step S437, the controller 101 finally stores the image file to which the authenticated user information has been added, in the management server. After execution of the step S437, the process proceeds to the step S438.

In the step S438, the controller 101 determines whether or not the buffer memory is in the empty state. The empty state of the buffer memory refers to a state in which all of the image files have been finally stored in the external medium or the management server, and there is no image file remaining in the buffer memory. If it is determined by the controller 101 in the step S438 that the buffer memory is in the empty state, the process proceeds to a step S441. On the other hand, if it is determined by the controller 101 in the step S438 that the buffer memory is not in the empty state, the process remains in the S438.

In the step S439 after execution of the step S433, the controller 101 collectively deletes the image files remaining in the buffer memory in the memory section 108, which have been temporarily stored. After execution of the step S439, the process proceeds to a step S440.

In the step S440, similar to the step S236, the controller 101 displays the authentication failure information display guidance 307 on the display section 104 in the state superimposed on the live view video 301. After execution of the step S440, the process proceeds to the step S441.

In the step S441, the controller 101 clears the authenticated user information stored in the memory section 108 and inhibits an image file from being stored (registered) in the management server. After execution of the step S441, the process is terminated.

In the above-described control, in a case where the biometric authentication process has finally failed (step S433), the image files stored in the buffer memory are collectively deleted (step S439). In this case, no image file is recorded in the recording section 109 at all . This makes it possible to prevent an image file to which the photographer information is not added due to a failure in the biometric authentication process from being recorded in the recording section 109. Further, in a case where it is determined, before the stop of the image capturing process, that the buffer memory usage is not smaller than the predetermined value (step S426) as well, the image files stored in the buffer memory are collectively deleted (step S439). When the empty state of the buffer memory becomes relatively small, the capacity for temporarily storing an image file in the buffer memory after that becomes insufficient. Therefore, it can be difficult to continue the image capturing process. In a case where the biometric authentication process has repeatedly failed, it is preferable to improve the state in which the biometric authentication process fails before it becomes difficult to continue the image capturing process. To cope with this, by collectively deleting the image files in the buffer memory, for which the biometric authentication process has failed, it is possible to continue the image capturing process. The deletion of the image files in the buffer memory thus performed is convenient for the user from the viewpoint of preventing an image file having no photographer information added thereto from being recorded in the recording section 109.

Further, by performing the control to limit the image capturing frame rate (step S407), increase of the buffer memory usage during execution of the biometric authentication process is suppressed. Further, in the above-described control, it is possible to gain time until the buffer memory usage becomes equal to or larger than the predetermined value after the start of the image capturing process (step S426) and thereafter the image files in the buffer memory are collectively deleted. Although the biometric authentication process takes time as described above, it is possible to sufficiently secure the time for the biometric authentication process since it is possible to gain time until the image files in the buffer memory are collectively deleted. This makes it possible to increase the success rate of the biometric authentication process. Further, the biometric authentication process is executed again (step S421). With the combination of the processing for re-executing the biometric authentication process and the processing for suppressing increase of the buffer memory usage, it is possible to sufficiently secure the number of times of re-execution trials of the biometric authentication process in a case where the biometric authentication process fails. This makes it possible to increase the success rate of the biometric authentication process. Further, before detecting the SW2 (step S408), the biometric authentication process is started according to detection of the SW0 (step S403). This control contributes to gaining time required to execute the biometric authentication process until the buffer memory usage becomes equal to or larger than the predetermined value. Note that whether or not to repeat execution of the biometric authentication process can be determined based on the lapse of a predetermined time period after the start of the biometric authentication process. Further, although the image capturing process and the biometric authentication process are started according to a result of detection of the SW0, this is not limitative, but the image capturing process and the biometric authentication process can be started according to detection of the SW1. Then, in both of the cases, the biometric authentication process is started before starting the image capturing process, and it is possible to gain the time required to execute the biometric authentication process.

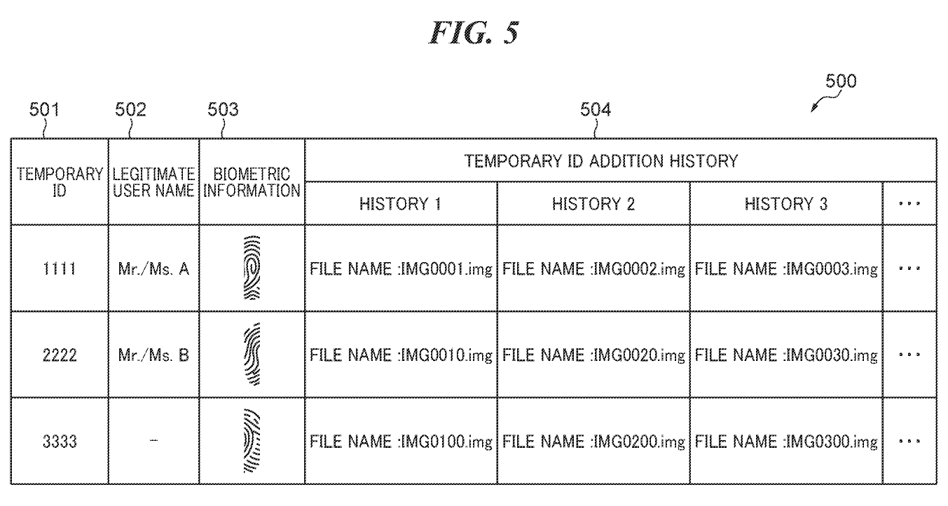

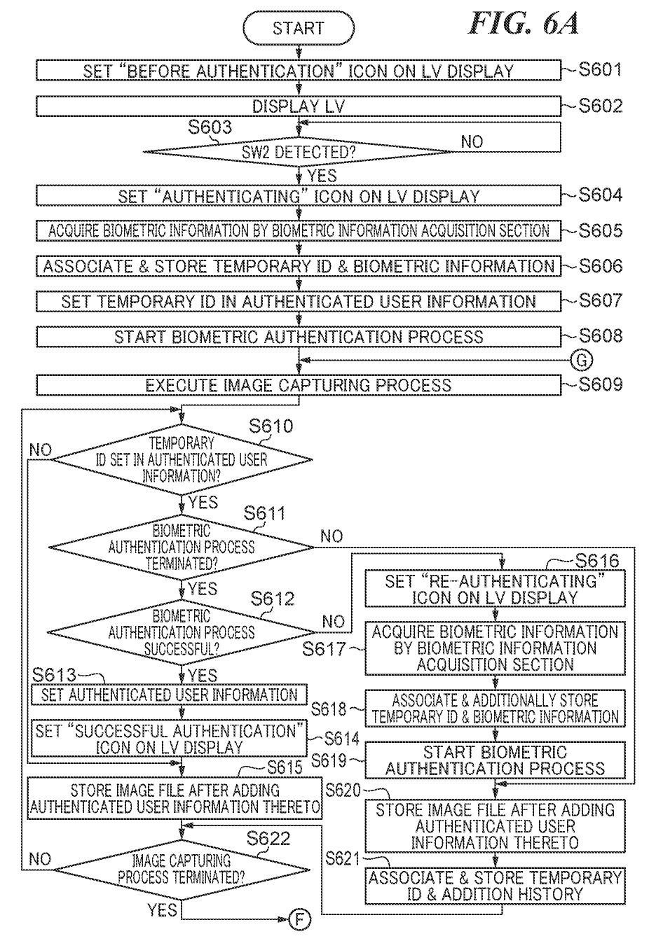

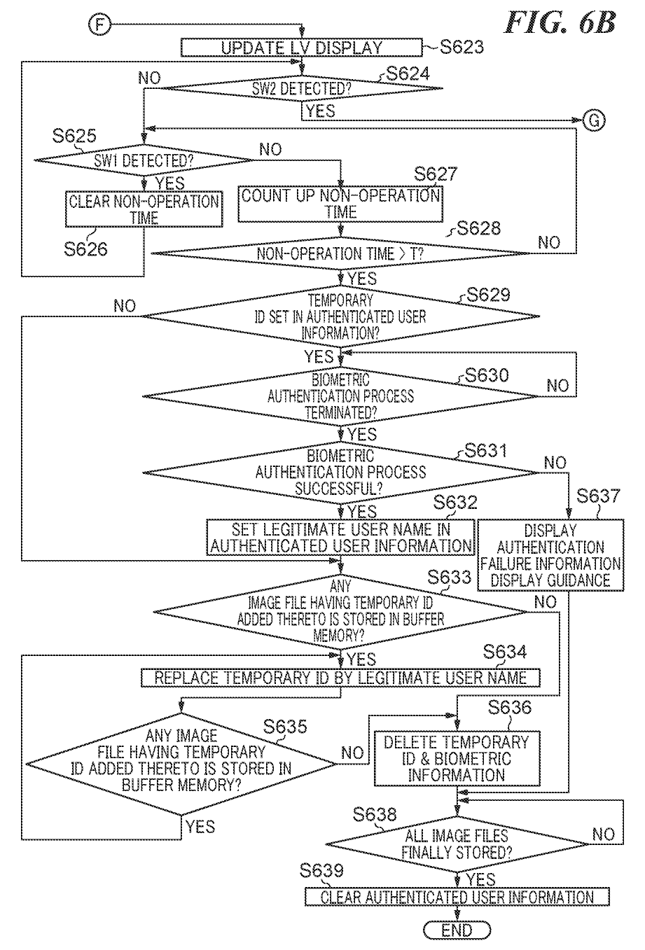

A third embodiment will be described below with reference to FIGS. 5, 6A, and 6B, but the description will be given mainly of a different point from the above-described embodiments, and description of the same points is omitted. The present embodiment is the same as the first embodiment except that in a case where the biometric authentication process has not been terminated or the biometric authentication process has failed, before the image capturing process is terminated, a temporary ID is added to an image file and the resulting image file is recorded. Further, in the present embodiment, in a case where the biometric authentication process is successful, the temporary ID of the image file to which the temporary ID has been added is replaced by (changed to) a legitimate user name, and then the resulting image file is recorded. FIG. 5 is a diagram showing a user database stored in the memory section of the image capturing apparatus according to the third embodiment. Referring to FIG. 5, in the user database, denoted by reference numeral 500, a temporary ID 501, a legitimate user name 502, biometric information 503, and temporary ID addition history 504 are registered in a state associated with each other. The temporary ID 501 is information related to the biometric information 503, and is photographer information for provisionally identifying a photographer. The temporary ID 501 is generated by the controller 101. Thus, the controller 101 also functions as a generation unit configured to generate the temporary ID 501. Note that the temporary ID 501 is generated before provisionally adding the temporary ID 501. Further, in the image capturing apparatus 100, a part which functions as the generation unit can be provided separately from the controller 101. The legitimate user name 502 is photographer information registered by a photographer at the time of registering the photographer. Note that in a case where the biometric information of a legitimate user, which matches the biometric information 503 acquired when the temporary ID 501 has been generated, has not been registered, the field of the legitimate user name is blank. The biometric information 503 is information acquired by the biometric information acquisition section 110. The temporary ID addition history 504 is addition history for identifying an image file to which the temporary ID 501 has been added and is information associated with the image file. For the temporary ID addition history 504, a name of an image file to which the temporary ID 501 has been added is used in the present embodiment, but the temporary ID addition history 504 is not limited to this. For another example of the temporary ID addition history 504, information included in metadata attached to an image file, information acquired by processing an image file, or the like can be used.

FIGS. 6A and 6B are a flowchart of a process performed by the image capturing apparatus. Referring to FIG. 6A, similar to the step S201, in a step S601, the controller 101 performs preparation for displaying the icon 302 on the display section 104 in the state superimposed on the live view video 301. After execution of the step S601, the process proceeds to a step S602.

Similar to the step S202, in the step S602, the controller 101 displays the live view video 301, on which the icon 302 prepared in the step S601 is superimposed, on the display section 104. After execution of the step S602, the process proceeds to a step S603.

Similar to the step S203, in the step S603, the controller 101 determines whether or not the SW2 of the release button 1002 has been detected. If it is determined by the controller 101 in the step S603 that the SW2 has been detected, the process proceeds to a step S604. On the other hand, if it is determined by the controller 101 in the step S603 that the SW2 has not been detected, the process remains in the step S603.

Similar to the step S204, in the step S604, the controller 101 performs preparation for displaying the icon 303 on the display section 104 in the state superimposed on the live view video 301. After execution of the step S604, the process proceeds to a step S605.

Similar to the step S206, in the step S605, the controller 101 controls the biometric information acquisition section 110 to acquire the biometric information of the photographer who performs shooting by operating the image capturing apparatus 100. After execution of the step S605, the process proceeds to a step S606.

In the step S606, the controller 101 generates the temporary ID 501 and stores the generated temporary ID 501 in the memory section 108 in a state associated with the biometric information acquired in the step S605. After execution of the step S606, the process proceeds to a step S607.

In the step S607, the controller 101 sets the temporary ID 501 generated in the step S606 in the authenticated user information. After execution of the step S607, the process proceeds to a step S608.

Similar to the step S207, in the step S608, the controller 101 starts the biometric authentication process. After execution of the step S608, the process proceeds to a step S609.

Similar to the step S208, in the step S609, the controller 101 controls the image capturing section 105 to start the image capturing process. After execution of the step S609, the process proceeds to a step S610.

In the step S610, the controller 101 determines whether or not the temporary ID 501 has been set in the authenticated user information. If it is determined by the controller 101 in the step S610 that the temporary ID 501 has been set in the authenticated user information, the process proceeds to a step S611. On the other hand, if it is determined by the controller 101 in the step S610 that the temporary ID 501 has not been set in the authenticated user information, the process proceeds to a step S615.

Similar to the step S210, in the step S611, the controller 101 determines whether or not the biometric authentication process has been terminated. If it is determined by the controller 101 in the step S611 that the biometric authentication process has been terminated, the process proceeds to a step S612. On the other hand, if it is determined by the controller 101 in the step S611 that the biometric authentication process has not been terminated, the process proceeds to a step S620.

Similar to the step S211, in the step S612, the controller 101 determines whether or not the biometric authentication process is successful as a result of the biometric authentication process terminated in the step S611. If it is determined by the controller 101 in the step S612 that the biometric authentication process is successful, the process proceeds to a step S613. On the other hand, if it is determined by the controller 101 in the step S612 that the biometric authentication process has failed, the process proceeds to a step S616.

Similar to the step S212, in the step S613, the controller 101 stores the legitimate user name which is the photographer name of the photographer who is permitted to use the image capturing apparatus 100, in the memory section 108 as the authenticated user information. After execution of the step S613, the process proceeds to a step S614.

Similar to the step S213, in the step S614, the controller 101 performs preparation for displaying the icon 304 on the display section 104 in the state superimposed on the live view video 301. After execution of the step S614, the process proceeds to the step S615.

Similar to the step S214, in the step S615, the controller 101 finally stores the image file to which the authenticated user information has been added, in the management server recording section 109. After execution of the step S615, the process proceeds to a step S622.

In the step S616 after execution of the step S612, the controller 101 performs preparation for displaying the icon 305 on the display section 104 in the state superimposed on the live view video 301. After execution of the step S616, the process proceeds to a step S617.

Similar to the step S206, in the step S617, the controller 101 controls the biometric information acquisition section 110 to acquire the biometric information of the photographer who performs shooting by operating the image capturing apparatus 100. After execution of the step S617, the process proceeds to a step S618.

In the step S618, the controller 101 additionally stores the temporary ID 501 stored in the memory section 108 in the step S606, and the biometric information acquired in the step S617, in the memory section 108 in a state associated with the temporary ID 501. The biometric information which can be acquired during the shooting operation performed by the photographer can be changed, and hence it is preferable to additionally store the biometric information in the state associated with the temporary ID 501. This is because, since the icon 305 indicating the re-authenticating state is displayed in the step S616, the photographer takes a countermeasure, such as an operation of correcting the position of his/her finger with respect to the fingerprint authentication sensor, and hence there is a possibility that the biometric information which can be acquired is changed. After execution of the step S618, the process proceeds to a step S619.

Similar to the step S207, in the step S619, the controller 101 starts the biometric authentication process. After execution of the step S619, the process proceeds to the step S620.

Similar to the step S214, in the step S620, the controller 101 finally stores the image file to which the authenticated user information has been added, in the recording section 109. After execution of the step S620, the process proceeds to a step S621.

In the step S621, the controller 101 stores the temporary ID 501 stored in the memory section 108 in the step S606, and the name of the image file, data of which has been transferred to the recording section 109, in the memory section 108, in an associated state as the temporary ID addition history 504. After execution of the step S621, the process proceeds to the step S622.

Similar to the step S222, in the step S622, the controller 101 determines whether or not the image capturing process has been terminated. If it is determined by the controller 101 in the step S622 that the image capturing process has been terminated, the process proceeds to a step S623 in FIG. 6B. On the other hand, if it is determined by the controller 101 in the step S622 that the image capturing process has not been terminated, the process returns to the step S610, and the step S610 et seq. are sequentially executed.

Similar to the step S223, in the step S623, the controller 101 updates the live view video 301 displayed on the display section 104. After execution of the step S623, the process proceeds to a step S624.

Similar to the step S203, in the step S624, the controller 101 determines whether or not the SW2 of the release button 1002 has been detected. If it is determined by the controller 101 in the step S624 that the SW2 has been detected, the process returns to the step S609, and the step S609 et seq. are sequentially executed. On the other hand, if it is determined by the controller 101 in the step S624 that the SW2 has not been detected, the process proceeds to a step S625.

Similar to the step S227, in the step S625, the controller 101 determines whether or not the SW1 of the release button 1002 has been detected. If it is determined by the controller 101 in the step S625 that the SW1 has been detected, the process proceeds to a step S626. On the other hand, if it is determined by the controller 101 in the step S625 that the SW1 has not been detected, the process proceeds to a step S627.

Similar to the step S230, in the step S626, the controller 101 clears the non-operation time period. After execution of the step S626, the process returns to the step S623, and the step S623 et seq. are sequentially executed.

Similar to the step S228, in the step S627, the controller 101 counts up the non-operation time period. After execution of the step S627, the process proceeds to a step S628.

Similar to the step S229, in the step S628, the controller 101 determines whether or not the non-operation time period has exceeded the predetermined time period T. If it is determined by the controller 101 in the step S628 that the non-operation time period has exceeded the predetermined time period T, the process proceeds to a step S629. On the other hand, if it is determined by the controller 101 in the step S628 that the non-operation time period has not exceeded the predetermined time period T, the process returns to the step S625, and the step S625 et seq. are sequentially executed.

Similar to the step S610, in the step S629, the controller 101 determines whether or not the temporary ID 501 has been set in the authenticated user information. If it is determined by the controller 101 in the step S629 that the temporary ID 501 has been set in the authenticated user information, the process proceeds to a step S630. On the other hand, if it is determined by the controller 101 in the step S629 that the temporary ID 501 has not been set in the authenticated user information, the process proceeds to a step S633.

Similar to the step S210, in the step S630, the controller 101 determines whether or not the biometric authentication process has been terminated. If it is determined by the controller 101 in the step S630 that the biometric authentication process has been terminated, the process proceeds to a step S631. On the other hand, if it is determined by the controller 101 in the step S630 that the biometric authentication process has not been terminated, the process remains in the S630.

Similar to the step S211, in the step S631, the controller 101 determines whether or not the biometric authentication process is successful as a result of the biometric authentication process terminated in the step S630. If it is determined by the controller 101 in the step S631 that the biometric authentication process is successful, the process proceeds to a step S632. On the other hand, if it is determined by the controller 101 in the step S631 that the biometric authentication process has failed, the process proceeds to a step S637.

Similar to the step S212, in the step S632, the controller 101 stores the legitimate user name which is the photographer name of the photographer who is permitted to use the image capturing apparatus 100, in the memory section 108 as the authenticated user information. After execution of the step S632, the process proceeds to the step S633.

In the step S633, the controller 101 determines whether or not there is any image file, to which the temporary ID 501 stored in the step S606 has been added, stored in the buffer memory or the external medium. If it is determined by the controller 101 in the step S633 that there is any image file stored, the process proceeds to a step S634. On the other hand, if it is determined by the controller 101 in the step S633 that there is no image file stored, the process proceeds to a step S636.

In the step S634, the controller 101 changes the photographer information of the image file, to which the temporary ID 501 has been added, to the legitimate user name set in the authenticated user information. After execution of the step S634, the process proceeds to a step S635.

Similar to the step S633, in the step S635, the controller 101 determines whether or not there is any image file, to which the temporary ID 501 stored in the step S606 has been added, stored in the buffer memory or the external medium. If it is determined by the controller 101 in the step S635 that there is any image file stored, the process returns to the step S634. On the other hand, if it is determined by the controller 101 in the step S635 that there is no image file stored, the process proceeds to the step S636.

In the step S636, the controller 101 deletes the temporary ID 501 and the biometric information, which are generated in the step S606, and the temporary ID addition history 504 stored in the step S621. After execution of the step S636, the process proceeds to a step S638.

Similar to the step S236, in the step S637, the controller 101 displays the authentication failure information display guidance 307 (see FIG. 3F) on the display section 104 in the state superimposed on the live view video 301. After execution of the step S637, the process proceeds to the step S638.

Similar to the step S238, in the step S638, the controller 101 determines whether or not all of the image files temporarily stored in the buffer memory of the system memory section 107 have been finally stored in the recording section 109. If it is determined by the controller 101 in the step S638 that all of the image files have been finally stored in the recording section 109, the process proceeds to a step S639. On the other hand, if it is determined by the controller 101 in the step S638 that not all of the image files have been finally stored in the recording section 109, the process remains in the S638.

Similar to the step S239, in the step S639, the controller 101 clears the authenticated user information stored in the memory section 108, followed by terminating the present process.

In the control described above, the temporary ID 501 is generated (step S606), the generated temporary ID 501 is set in the authenticated user information (step S607), and then, writing of the image file into the external medium is permitted. With this, it is possible to temporarily add the temporary ID 501 to an image file and store the image file in the recording section 109, and as a result, it is possible to store the image file without being affected e.g. by the processing time and the processing result of the biometric authentication process. Further, by confirming that the photographer information of the image file is the temporary ID 501, the photographer can grasp that the image file is an image file for which the biometric authentication process has failed. Further, in the above-described control, whether or not there is an image file stored, to which the temporary ID 501 has been added, is determined (step S633). Then, if an image file, to which the temporary ID 501 has been added, has been stored, the temporary ID 501 is replaced by the legitimate user name (step S634). With this, the reliability that the image file has been photographed by the photographer of the legitimate user name is increased. Further, the temporary ID 501, the biometric information, and the temporary ID addition history 504 are deleted (step S636). This contributes to reduction of the usage of the memory section 108. Further, the temporary ID 501 and the temporary ID addition history 504 are stored in a state associated with each other (step S621). With this, when replacing the temporary ID 501 of the image file by the legitimate user name, after user registration, it is possible to prevent the information of the image file as the replacement target from being tampered. Further, the temporary ID 501 can be temporarily stored in the system memory section 107, and in a case where the biometric authentication process fails after completion of all the image capturing process operations and the legitimate user name cannot be added, can be stored in the memory section 108. Further, also in a case where the image capturing process is performed without performing user registration, it is possible to correctly add the photographer information by performing user registration thereafter.

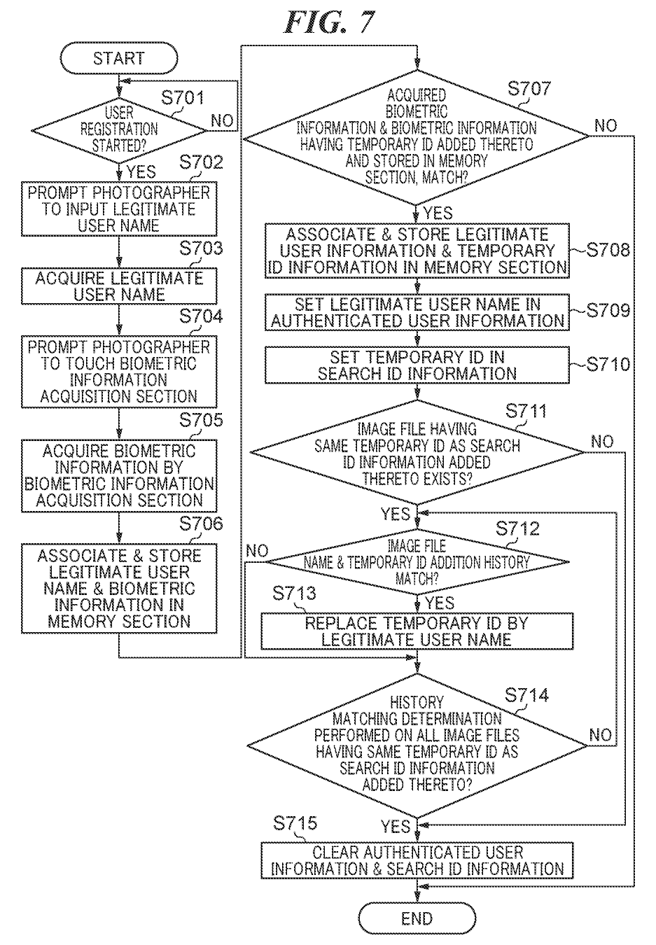

A fourth embodiment will be described below with reference to FIG. 7, but the description will be given mainly of different points from the above-described embodiments, and description of the same points is omitted. FIG. 7 is a flowchart of a process performed by the image capturing apparatus according to the fourth embodiment. Referring to FIG. 7, in a step S701, the controller 101 determines whether or not an instruction for starting user registration has been received from the operation section 106. If it is determined by the controller 101 in the step S701 that an instruction for starting user registration has been received, the process proceeds to a step S702. On the other hand, if it is determined by the controller 101 in the step S701 that no instruction for starting user registration has been received, the process remains in the step S701.

In the step S702, the controller 101 displays an instruction (input notification) for inputting a legitimate user name to be registered in the user database on the display section 104. After execution of the step S702, the process proceeds to a step S703.

In the step S703, the controller 101 acquires the legitimate user name input on the operation section 106. After execution of the step S703, the process proceeds to a step S704.

In the step S704, the controller 101 displays a notification for prompting the photographer to touch the biometric information acquisition section 110 on the display section 104. After execution of the step S704, the process proceeds to a step S705.

Similar to the step S206, in the step S705, the controller 101 controls the biometric information acquisition section 110 to acquire the biometric information of the photographer who performs shooting by operating the image capturing apparatus 100. After execution of the step S705, the process proceeds to a step S706.

In the step S706, the controller 101 stores the legitimate user name acquired in the step S703 and the biometric information acquired in the step S705 in a state associated with each other, in the memory section 108 as the legitimate user information. After execution of the step S706, the process proceeds to a step S707.

In the step S707, the controller 101 determines whether or not the biometric information stored in the step S706 and the biometric information stored in the user database in the memory section 108 in association with the temporary ID match. If it is determined by the controller 101 in the step S707 that the two pieces of the information match, the process proceeds to a step S708. On the other hand, if it is determined by the controller 101 in the step S707 that the two pieces of the information do not match, the present process is terminated.

In the step S708, the controller 101 stores the legitimate user information and the temporary ID information in the memory section 108 in an associated state. After execution of the step S708, the process proceeds to a step S709.

In the step S709, the controller 101 sets the legitimate user name associated with the temporary ID information in the authenticated user information. After execution of the step S709, the process proceeds to a step S710.

In the step S710, the controller 101 sets the temporary ID associated with the legitimate user information stored in the step S708, in search ID information. After execution of the step S710, the process proceeds to a step S711.

In the step S711, the controller 101 determines whether or not there is an image file to which the same temporary ID as the search ID information has been added, in the recording section 109. If it is determined by the controller 101 in the step S711 that there is an image file to which the same temporary ID as the search ID information has been added, the process proceeds to a step S712. On the other hand, if it is determined by the controller 101 in the step S711 that there is no image file to which the same temporary ID as the search ID information has been added, the process proceeds to a step S715.

In the step S712, the controller 101 determines whether or not there is a match between the file name of the image file to which the same temporary ID as the search ID information has been added, in the recording section 109, and a file name in the temporary ID addition history stored in the memory section 108 in a state associated with the same temporary ID as the search ID information. Note that the information used for the determination in the step S712 is not limited to the file name of the image file but can be e.g. information in the metadata attached to the image file or information acquired by processing the image file. Further, in a case where the image file itself has been tampered, the image file does not match any file in the temporary ID addition history, and hence the temporary ID is not replaced by a legitimate user name. With this, it is also possible to correctly add the photographer information to an image file stored in the recording section 109 after adding the temporary ID thereto. Then, if it is determined by the controller 101 in the step S712 that the two pieces of the information match, the process proceeds to a step S713. On the other hand, if it is determined by the controller 101 in the step S712 that the pieces of the information do not match, the process proceeds to a step S714.

Similar to the step S634, in the step S713, the controller 101 changes the photographer information of the image file to which the temporary ID 501 has been added, to the legitimate user name set in the authenticated user information. Note that when changing the photographer information to the legitimate user name, this change can be collectively performed when user registration is performed, or can be collectively performed according to a menu operation performed by the photographer. After execution of the step S713, the process proceeds to the step S714.

In the step S714, the controller 101 determines whether or not the determination of whether or not the file name of the image file matches a file in the temporary ID addition history has been performed with respect to all of the image files stored in the recording section 109, to which the same temporary ID as the search ID information has been added. If it is determined by the controller 101 in the step S714 that the matching determination has been performed with respect to all of the image files, the process proceeds to the step S715. On the other hand, if it is determined by the controller 101 in the step S714 that the matching determination has been performed with respect to not all of the image files, the process returns to the step S712, and the step S712 et seq. are sequentially executed.

In the step S715, the controller 101 clears the authenticated user information and the search ID information, followed by terminating the present process.

In the above-described control, whether or not the two pieces of the biometric information match is determined (step S707), and as a result, the legitimate user information and the temporary ID information, which match in the biometric information, are associated and stored (step S708). With this, it is possible to correctly associate and store the legitimate user information which has been newly registered as the user and the temporary ID information.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-098788, filed June 19, 2024, which is hereby incorporated by reference herein in its entirety.

What is claimed is:

1. An image capturing apparatus comprising:
an image capturing unit configured to perform an image capturing process
for capturing an image to thereby generate image data; a temporary storage unit configured to temporarily store the image data for provisional storage; an acquisition unit configured to acquire biometric information of an operator who performs an operation of instructing the image capturing process; a biometric authentication unit configured to perform a biometric authentication process for authenticating the operator based on the biometric information acquired by the acquisition unit; and a control unit configured to control the image capturing unit, the temporary storage unit, the acquisition unit, and the biometric authentication unit, respectively, wherein the control unit controls the image capturing unit to start the image capturing process, controls the biometric authentication unit to start the biometric authentication process, temporarily stores the image data generated by the image capturing process in the temporary storage unit in a case where the
biometric authentication process is not terminated before the image capturing process is terminated, and adds, in a case where the biometric authentication process is terminated after the image data has been temporarily stored, a result of the biometric authentication process to the image data temporarily stored in the temporary storage unit.

2. The image capturing apparatus according to claim 1, wherein in a case where the biometric authentication process is terminated after the image data has
been temporarily stored, the control unit also adds a result of the biometric authentication process to the image data generated by the image capturing process after the biometric authentication process is terminated.

3. The image capturing apparatus according to claim 1, wherein the image capturing apparatus is communicably connected to a final storage unit configured to finally store the image data, and
wherein the control unit can finally store the image data to which a result of the biometric authentication process has been added, in the final storage unit.

4. The image capturing apparatus according to claim 3, wherein the final storage unit is a storage medium which is fixed or removably attached to the image capturing apparatus, or an external apparatus which is formed separately from the image capturing apparatus and is disposed at a location different from the
image capturing apparatus.

5. The image capturing apparatus according to claim 1, further comprising an information storage unit in which the biometric information is stored in advance, and
wherein as the biometric authentication process, the biometric authentication unit compares the biometric information acquired by the acquisition unit and the biometric information stored in the information storage unit in advance and determines whether or not these pieces of the biometric information match.

6. The image capturing apparatus according to claim 1, wherein the image is a still image, and
wherein in a case where the biometric authentication process is started by the biometric authentication unit, the control unit can perform control to reduce the number of still images which can be captured per unit time in the image capturing process, and can release the control to reduce the number of still images
to be captured, in a case where the biometric authentication process by the biometric authentication unit is terminated.

7. The image capturing apparatus according to claim 1, wherein as a result of the biometric authentication process, the control unit can add identification
information which enables identification of the operator.

8. The image capturing apparatus according to claim 1, further comprising a display unit controlled by the control unit to display a screen and
wherein the control unit controls the display unit to display processing
state information indicating an execution state of the biometric authentication process.

9. The image capturing apparatus according to claim 8, wherein as the processing state information, before the start of the biometric authentication
process, the control unit controls the display unit to display information indicating a state before the start of the biometric authentication process, controls, during execution of the biometric authentication process, the display unit to display information that the biometric authentication process is being executed, and
controls, after the biometric authentication process is terminated, the display unit
to display information indicating a state after the biometric authentication process is terminated.

10. The image capturing apparatus according to claim 9 wherein as the processing state information, the control unit controls, in a case where the biometric authentication process is successful, the display unit to display information that the biometric authentication process is successful, and controls,
in a case where the biometric authentication process has failed, the display unit to display information that the biometric authentication process has failed.

11. The image capturing apparatus according to claim 8, wherein the display unit can visualize the image data and display the image data together with
the processing state information.

12. An image capturing apparatus comprising:
an image capturing unit configured to perform an image capturing process for capturing an image to thereby generate image data;
an acquisition unit configured to acquire biometric information of an operator who performs an operation of instructing the image capturing process;
a biometric authentication unit configured to perform a biometric authentication process for authenticating the operator based on the biometric information acquired by the acquisition unit;
a detection unit configured to detect a first operation and a second operation, sequentially performed by the operator with a time difference therebetween; and
a control unit configured to control the image capturing unit, the acquisition unit, the biometric authentication unit, and the detection unit, respectively,
wherein in a case where the first operation is detected by the detection unit, the control unit controls the biometric authentication unit to perform the
biometric authentication process, and in a case where the biometric authentication process is successful, until the second operation is detected, the control unit adds information concerning the successful biometric authentication process to the image data generated by the image capturing process before the second operation
is detected.

13. The image capturing apparatus according to claim 12, further comprising a release button that is pressed in two steps when the operator performs an operation of instructing the image capturing process, and
wherein the detection unit detects a first-step pressing operation performed on the release button, as the first operation, and detects a second-step pressing operation performed on the release button, as the second operation.

14. The image capturing apparatus according to claim 12, further
comprising a release button pressed when the operator performs an operation of instructing the image capturing process, and wherein the detection unit detects a touch on the release button by the operator, as the first operation, and detects a pressing operation on the release button by the operator, as the second operation.

15. The image capturing apparatus according to claim 12, wherein the control unit can add identification information which enables identification of the operator, as the information indicating a success in the successful biometric authentication process.

16. An image capturing apparatus comprising:
an image capturing unit configured to perform an image capturing process
for capturing an image to thereby generate image data; an acquisition unit configured to acquire biometric information of an operator who performs an operation of instructing the image capturing process; a biometric authentication unit configured to perform a biometric
authentication process for authenticating the operator based on the biometric information acquired by the acquisition unit; and a control unit configured to control the image capturing unit, the acquisition unit, and the biometric authentication unit, respectively, wherein the control unit controls the image capturing unit to start the
image capturing process and controls the biometric authentication unit to start the biometric authentication process, and in a case where the biometric authentication process is not terminated before the image capturing process is terminated, the control unit temporarily adds information related to the biometric information to the image data generated by the image capturing process.

17. The image capturing apparatus according to claim 16, further comprising a generation unit configured to generate the related information before the control unit temporarily adds the related information.

18. The image capturing apparatus according to claim 16, wherein in a case where the biometric authentication process is terminated, the control unit can replace the related information added to the image data generated by the image capturing process by identification information which enables identification of the operator.

19. A method of controlling an image capturing apparatus, comprising:
performing an image capturing process for capturing an image to thereby
generate image data; temporarily performing provisional storage of the image data; acquiring biometric information of an operator who performs an operation of instructing the image capturing process; performing biometric authentication process for authenticating the operator based on the acquired biometric information; and controlling the capturing an image, the temporarily performing provisional storage, the acquiring, and the performing biometric authentication process respectively, wherein the controlling starts the image capturing process, starts the biometric authentication process, temporarily stores the image data generated by the image capturing process in a case where the biometric authentication process is not terminated before the image capturing process is terminated, and adds, in a case where the biometric authentication process is terminated after the temporarily
storing, a result of the biometric authentication process to the image data temporarily stored.

20. A non-transitory computer-readable storage medium storing a program for causing a computer to execute a method of controlling an image
capturing apparatus, wherein the method comprises: performing an image capturing process for capturing an image to thereby generate image data; temporarily performing provisional storage of the image data; acquiring biometric information of an operator who performs an operation of instructing the image capturing process; performing biometric authentication process for authenticating the
operator based on the acquired biometric information; and controlling the capturing an image, the temporarily performing provisional storage, the acquiring, and the performing biometric authentication process respectively, wherein the controlling starts the image capturing process, starts the biometric authentication process, temporarily stores the image data generated by the image capturing process in a case where the biometric authentication process is not terminated before the image capturing process is terminated, and adds, in a case where the biometric authentication process is terminated after the temporarily
storing, a result of the biometric authentication process to the image data temporarily stored.
